(19) United States
(12) Patent Application Publication
(10) Pub. No.: US 2025/0051372 A1
(43) Pub. Date: Feb. 13, 2025

(54) TIN AMIDE COMPOUNDS AND RELATED COMPOSITIONS AND METHODS

(71) Applicant: ENTEGRIS, INC., Billerica, MA (US)

(72) Inventors: Claudia Fafard, New Milford, CT (US); David M. Ermert, Danbury, CT (US); Drew Michael Hood, Newtown, CT (US)

(21) Appl. No.: 18/785,117

(22) Filed: Jul. 26, 2024

Related U.S. Application Data
(60) Provisional application No. 63/529,023, filed on Jul. 26, 2023.

(51) Int. Cl. C07F 7/22; C07F 7/08; C07F 7/28

(52) U.S. Cl. CPC C07F 7/2284; C07F 7/0836; C07F 7/28

(57) ABSTRACT

Methods are provided. A method comprises contacting a tin (IV) compound with a reagent to form at least one reaction product. The regent comprises at least one of a metal alkoxide compound, a metal amide compound, or any combination thereof. The at least one reaction product comprises at least one of a substituted tin (IV) amide compound, a substituted tin (IV) alkoxide compound, or any combination thereof. Various compositions and various compounds, among other things, are also provided.

### CROSS-REFERENCE TO RELATED APPLICATIONS

This application claims the benefit under 35 USC 119 of U.S. Provisional Patent Application No. 63/529,023, filed Jul. 26, 2023, the disclosure of which is hereby incorporated herein by reference in its entirety.

### FIELD

The present disclosure relates to tin amide compounds and related compositions and methods.

### BACKGROUND

Some precursors are useful in the manufacture of microelectronic devices. The manufacture of such devices can involve use of extreme ultraviolet (EUV) lithography to form thin films.

### SUMMARY

Some embodiments relate to a method of synthesis. In some embodiments, the method of synthesis comprises contacting a tin (IV) alkoxide compound with a metal amide compound to form at least one reaction product. In some embodiments, the tin (IV) alkoxide compound comprises a compound of the formula:

RₙSn(OR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3. In some embodiments, the metal amide compound comprises a compound of the formula:

M(NR″₂)ₐX_{b},
where:
M is an alkali metal cation, an alkaline earth metal cation, a transition metal cation, or a post-transition metal cation;
R″ is independently a hydrogen, an alkyl, a cycloalkyl, an aryl, or a silyl, or are bonded to each other to form a C₃-C₂₀ N-heterocycle;
X is independently a cyclopentadienyl, an indenyl, a chloro, a bromo, an iodo, or a fluoro; and

a+b=2to 5.

Some embodiments relate to a composition. In some embodiments, the composition comprises a tin (IV) amide compound of the formula:

RₙSn(NR″₂)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is independently a hydrogen, an alkyl, a cycloalkyl, an aryl, or a silyl, or are bonded to each other to form a C₃-C₂₀ N-heterocycle; and n is 0 to 3.

Some embodiments relate to a composition. In some embodiments, the composition comprises a metal alkoxide compound of the formula:

M(OR′)_{q},
where:
M is an alkali metal cation, an alkaline earth metal cation, a transition metal cation, or a post-transition metal cation;
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

Some embodiments relate to a method. In some embodiments, the method comprises contacting a tin (IV) compound with a reagent to form at least one reaction product. In some embodiments, the tin (IV) compound comprises a compound of the formula:

RₙSn(Q)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3. In some embodiments, the reagent comprises at least one of a metal alkoxide compound, a metal amide compound, or any combination thereof.

Some embodiments relate to a method. In some embodiments, the method comprises contacting a tin (IV) compound with a metal alkoxide compound to form at least one reaction product. In some embodiments, the tin (IV) compound comprises a compound of the formula:

RₙSn(Q)₄₋ₙ,
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3. In some embodiments, the metal alkoxide compound comprises a compound of the formula:

M(OR″)ₙ,
where:
M is an alkali metal cation, an alkaline earth metal cation, a transition metal cation, or a post-transition metal cation;
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 1 to 5.

Some embodiments relate to a method. In some embodiments, the method comprises contacting a tin (IV) compound with a metal alkoxide compound to form at least one reaction product. In some embodiments, the tin (IV) compound comprises a compound of the formula:

RₙSn(Q)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3. In some embodiments, the metal alkoxide compound comprises a compound of the formula:

[M(OR″)2]ₙ,
where:
M is an alkali metal cation, an alkaline earth metal cation, a transition metal cation, or a post-transition metal cation;
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 1 or 2.

Some embodiments relate to a method. In some embodiments, the method comprises contacting a tin (IV) compound with a metal amide compound to form at least one reaction product. In some embodiments, the tin (IV) compound comprises a compound of the formula:

RₙSn(Q)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3. In some embodiments, the metal amide compound comprises a compound of the formula:

M(NR″₂)ₐX_{b},
where:
M is an alkali metal cation, an alkaline earth metal cation, a transition metal cation, or a post-transition metal cation;
R″ is independently a hydrogen, an alkyl, a cycloalkyl, an aryl, or a silyl, or are bonded to each other to form a C₃-C₂₀ N-heterocycle;
X is independently a cyclopentadienyl, an indenyl, a chloro, a bromo, an iodo, or a fluoro; and

a+b=2 to 5.

Some embodiments relate to a method. In some embodiments, the method comprises contacting a tin (IV) compound with a reagent to form at least one reaction product. In some embodiments, the tin (IV) compound comprises a compound of the formula:

RₙSn(Q)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3. In some embodiments, the metal amide compound comprises a compound of the formula:

[M(NR″₂)₂]ₙ,
M is an alkali metal cation, an alkaline earth metal cation, a transition metal cation, or a post-transition metal cation;
R″ is independently a hydrogen, an alkyl, a cycloalkyl, an aryl, or a silyl, or are bonded to each other to form a C₃-C₂₀ N-heterocycle; and
n is 1 or 2.

Some embodiments relate to a composition. In some embodiments, the composition comprises a tin (IV) carboxylate compound of the formula:

RₙSn(O₂CR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R′ is at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

Some embodiments relate to a composition. In some embodiments, the composition comprises a tin (IV) amide compound of the formula:

RₙSn(NR″₂)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is independently a hydrogen, an alkyl, a cycloalkyl, an aryl, or a silyl, or are bonded to each other to form a C₃-C₂₀ N-heterocycle; and
n is 0 to 3.

Some embodiments relate to a composition. In some embodiments, the composition comprises a tin (IV) alkoxide compound of the formula:

RₙSn(OR″)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 0 to 3.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a flowchart of a method of synthesis, according to some embodiments.

FIG. 2 depicts a reaction scheme of a method of synthesis, according to some embodiments.

FIG. 3 depicts a reaction scheme of a method of synthesis for a tin (IV) amide compound which is substituted with an isopropyl group, according to some embodiments.

FIG. 4 depicts a reaction scheme of a method of synthesis for a tin (IV) amide compound which is substituted with an isopropyl group, according to some embodiments.

FIG. 5 depicts a reaction scheme of a method of synthesis for a tin (IV) amide compound which is substituted with a vinyl group, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “contacting” refers to bringing two or more components into immediate or close proximity, or into direct contact.

As used herein, the term “alkyl” refers to a hydrocarbyl having from 1 to 30 carbon atoms. The alkyl may be attached via a single bond. An alkyl having n carbon atoms may be designated as a “Cn alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₈ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, neo-pentyl, n-hexyl, isohexyl, 3-methylhexyl, 2-methylhexyl, heptyl, octyl, nonyl, decyl, dodecyl, octadecyl, or any combination thereof. In some embodiments, the alkyl is methyl. In some embodiments, the alkyl is isopropyl. In some embodiments, the alkyl is tert-butyl. In some embodiments, the term “alkyl” refers generally to alkyls, alkenyls, alkynyls, and/or cycloalkyls.

As used herein, the term “alkenyl” refers to a hydrocarbyl having from 1 to 30 carbon atoms and at least one carbon-carbon double bond. In some embodiments, the alkenyl comprises or is selected from the group consisting of at least one of a C₁-C₃₀ alkenyl, C₁-C₂₉ alkenyl, C₁-C₂₈ alkenyl, C₁-C₂₇ alkenyl, C₁-C₂₇ alkenyl, C₁-C₂₆ alkenyl, C₁-C₂₅ alkenyl, C₁-C₂₄ alkenyl, C₁-C₂₃ alkenyl, C₁-C₂₂ alkenyl, C₁-C₂₁ alkenyl, C₁-C₂₀ alkenyl, C₁-C₁₉ alkenyl, C₁-C₁₈ alkenyl, C₁-C₁₇ alkenyl, C₁-C₁₆ alkenyl, C₁-C₁₅ alkenyl, C₁-C₁₄ alkenyl, C₁-C₁₃ alkenyl, C₁-C₁₂ alkenyl, C₁-C₁₁ alkenyl, C₁-C₁₀ alkenyl, a C₁-C₉ alkenyl, a C₁-C₈ alkenyl, a C₁-C₇ alkenyl, a C₁-C₆ alkenyl, a C₁-C₅ alkenyl, a C₁-C₄ alkenyl, a C₁-C₃ alkenyl, a C₁-C₂ alkenyl, a C₂-C₃₀ alkenyl, a C₃-C₃₀ alkenyl, a C₄-C₃₀ alkenyl, a C₅-C₃₀ alkenyl, a C₆-C₃₀ alkenyl, a C₇-C₃₀ alkenyl, a C₈-C₃₀ alkenyl, a C₉-C₃₀ alkenyl, a C₁₀-C₃₀ alkenyl, a C₁₁-C₃₀ alkenyl, a C₁₂-C₃₀ alkenyl, a C₁₃-C₃₀ alkenyl, a C₁₄-C₃₀ alkenyl, a C₁₅-C₃₀ alkenyl, a C₁₆-C₃₀ alkenyl, a C₁₇-C₃₀ alkenyl, a C₁₈-C₃₀ alkenyl, a C₁₉-C₃₀ alkenyl, a C₂₀-C₃₀ alkenyl, a C₂₁-C₃₀ alkenyl, a C₂₂-C₃₀ alkenyl, a C₂₃-C₃₀ alkenyl, a C₂₄-C₃₀ alkenyl, a C₂₅-C₃₀ alkenyl, a C₂₆-C₃₀ alkenyl, a C₂₇-C₃₀ alkenyl, a C₂₈-C₃₀ alkenyl, a C₂₉-C₃₀ alkenyl, a C₂-C₁₀ alkenyl, a C₃-C₁₀ alkenyl, a C₄-C₁₀ alkenyl, a C₅-C₁₀ alkenyl, a C₆-C₁₀ alkenyl, a C₇-C₁₀ alkenyl, a C₈-C₁₀ alkenyl, a C₂-C₉ alkenyl, a C₂-C₅ alkenyl, a C₂-C₇ alkenyl, a C₂-C₆ alkenyl, a C₂-C₅ alkenyl, a C₃-C₅ alkenyl, or any combination thereof. Examples of alkenyl groups include, without limitation, at least one of vinyl, allyl, 1-methylvinyl, 1-propenyl, 1-butenyl, 2-butenyl, 3-butenyl, 1,3-butadienyl, 2-methyl-1-propenyl, 2-methyl-2-propenyl, 1-pentenyl, 2-pentenyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 3-heptenyl, 1-octenyl, 1,3-octadienyl, 1-nonenyl, 2-nonenyl, 3-nonenyl, 1-decenyl, 3-decenyl, 1-undecenyl, oleyl, linoleyl, linolenyl, or any combination thereof. In some embodiments, the alkenyl is vinyl. In some embodiments, the alkenyl is an isopropenyl.

As used herein, the term “alkynyl” refers to a hydrocarbyl having from 1 to 30 carbon atoms and at least one carbon-carbon triple bond. In some embodiments, the alkynyl comprises or is selected from the group consisting of at least one of a C₁-C₃₀ alkynyl, C₁-C₂₉ alkynyl, C₁-C₂₈ alkynyl, C₁-C₂₇ alkynyl, C₁-C₂₇ alkynyl, C₁-C₂₆ alkynyl, C₁-C₂₅ alkynyl, C₁-C₂₄ alkynyl, C₁-C₂₃ alkynyl, C₁-C₂₂ alkynyl, C₁-C₂₁ alkynyl, C₁-C₂₀ alkynyl, C₁-C₁₉ alkynyl, C₁-C₁₈ alkynyl, C₁-C₁₇ alkynyl, C₁-C₁₆ alkynyl, C₁-C₁₅ alkynyl, C₁-C₁₄ alkynyl, C₁-C₁₃ alkynyl, C₁-C₁₂ alkynyl, C₁-C₁₁ alkynyl, C₁-C₁₀ alkynyl, a C₁-C₉ alkynyl, a C₁-C₈ alkynyl, a C₁-C₇ alkynyl, a C₁-C₆ alkynyl, a C₁-C₅ alkynyl, a C₁-C₄ alkynyl, a C₁-C₈ alkynyl, a C₁-C₂ alkynyl, a C₂-C₃₀ alkynyl, a C₃-C₃₀ alkynyl, a C₄-C₃₀ alkynyl, a C₅-C₃₀ alkynyl, a C₆-C₃₀ alkynyl, a C₇-C₃₀ alkynyl, a C₈-C₃₀ alkynyl, a C₉-C₃₀ alkynyl, a C₁₀-C₃₀ alkynyl, a C₁₁-C₃₀ alkynyl, a C₁₂-C₃₀ alkynyl, a C₁₃-C₃₀ alkynyl, a C₁₄-C₃₀ alkynyl, a C₁₅-C₃₀ alkynyl, a C₁₆-C₃₀ alkynyl, a C₁₇-C₃₀ alkynyl, a C₁₈-C₃₀ alkynyl, a C₁₉-C₃₀ alkynyl, a C₂₀-C₃₀ alkynyl, a C₂₁-C₃₀ alkynyl, a C₂₂-C₃₀ alkynyl, a C₂₃-C₃₀ alkynyl, a C₂₄-C₃₀ alkynyl, a C₂₅-C₃₀ alkynyl, a C₂₆-C₃₀ alkynyl, a C₂₇-C₃₀ alkynyl, a C₂₈-C₃₀ alkynyl, a C₂₉-C₃₀ alkynyl, a C₂-C₁₀ alkynyl, a C₃-C₁₀ alkynyl, a C₄-C₁₀ alkynyl, a C₅-C₁₀ alkynyl, a C₆-C₁₀ alkynyl, a C₇-C₁₀ alkynyl, a C₈-C₁₀ alkynyl, a C₂-C₉ alkynyl, a C₂-C₈ alkynyl, a C₂-C₇ alkynyl, a C₂-C₆ alkynyl, a C₂-C₅ alkynyl, a C₃-C₅ alkynyl, or any combination thereof. Examples of alkynyl groups include, without limitation, at least one of ethynyl, propynyl, n-butynyl, n-pentynyl, 3-methyl-1-butynyl, n-hexynyl, methyl-pentynyl, or any combination thereof.

As used herein, the term “cycloalkyl” refers to a non-aromatic carbocyclic ring having from 3 to 8 carbon atoms in the ring. The term includes a monocyclic non-aromatic carbocyclic ring and a polycyclic non-aromatic carbocyclic ring. The term “monocyclic,” when used as a modifier, refers to a cycloalkyl having a single cyclic ring structure. The term “polycyclic,” when used as a modifier, refers to a cycloalkyl having more than one cyclic ring structure, which may be fused, bridged, spiro, or otherwise bonded ring structures. For example, two or more cycloalkyls may be fused, bridged, or fused and bridged to obtain the polycyclic non-aromatic carbocyclic ring. In some embodiments, the cycloalkyl may comprise, consist of, or consist essentially of, or may be selected from the group consisting of, at least one of cyclopropyl, cyclobutyl, cyclopentyl, cyclohexyl, cycloheptyl, cyclooctyl, or any combination thereof.

As used herein, the term “aryl” refers to a monocyclic or polycyclic aromatic hydrocarbon. The number of carbon atoms of the aryl may be in a range of 5 carbon atoms to 100 carbon atoms. In some embodiments, the aryl has 5 to 20 carbon atoms. For example, in some embodiments, the aryl has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an aryl having a single aromatic ring structure. The term “polycyclic,” when used as a modifier, refers to an aryl having more than one aromatic ring structure, which may be fused, bridged, spiro, or otherwise bonded ring structures. In some embodiments, the aryl is —C₆H₅. In some embodiments, the aryl is a phenyl.

As used herein, the term “amino” refers to a functional group of formula —N(R^{a}R^{b}), wherein R^{a} and R^{b} are independently a hydrogen, an alkyl (as defined herein), or a silyl (as defined herein), or R^{a} and R^{b} are bonded to each other to form a C₃-C₂₀ N-heterocycle. In some embodiments, the amino may comprise an alkylamino or a dialkylamino. In some embodiments, the amino may comprise at least one of methylamino, dimethylamino, ethylamino, diethylamino, isopropylamino, diisopropylamino, butylamino, sec-butylamino, tert-butylamino, di-sec-butylamino, isobutylamino, di-isobutylamino, di-tert-pentylamino, ethylmethylamino, isopropyl-n-propylamino, or any combination thereof. Examples of the alkylaminos may include, without limitation, one or more of the following: primary alkylaminos, such as, for example and without limitation, methylamino, ethylamino, n-propylamino, isopropylamino, n-butylamino, sec-butylamino, isobutylamino, t-butylamino, pentylamino, 2-aminopentane, 3-aminopentane, 1-amino-2-methylbutane, 2-amino-2-methylbutane, 3-amino-2-methylbutane, 4-amino-2-methylbutane, hexylamino, 5-amino-2-methylpentane, heptylamino, octylamino, nonylamino, decylamino, undecylamino, dodecylamino, tridecylamino, tetradecylamino, pentadecylamino, hexadecylamino, heptadecylamino, and octadecylamino; and secondary alkylaminos, such as, for example and without limitation, dimethylamino, diethylamino, dipropylamino, diisopropylamino, dibutylamino, diisobutylamino, di-sec-butylamino, di-t-butylamino, dipentylamino, dihexylamino, diheptylamino, dioctylamino, dinonylamino, didecylamino, methylethylamino, methylpropylamino, methylisopropylamino, methylbutylamino, methylisobutylamino, methyl-sec-butylamino, methyl-t-butylamino, methylamylamino, methylisoamylamino, ethylpropylamino, ethylisopropylamino, ethylbutylamino, ethylisobutylamino, ethyl-sec-butylamino, ethylamino, ethylisoamylamino, propylbutylamino, and propylisobutylamino.

As used herein, the term “alkoxy” refers to a functional group of formula —OR^{c}, wherein R^{c} is an alkyl (as defined herein), a silylalkyl, a cycloalkyl, or an aryl. In some embodiments, the alkoxy may comprise, consist of, or consist essentially of, or may selected from the group consisting of, at least one of methoxy, ethoxy, methoxy, ethoxy, n-propoxy, 1-methylethoxy (isopropoxy), n-butoxy, iso-butoxy, sec-butoxy, tert-butoxy, or any combination thereof.

As used herein, the term “silyl” refers to a functional group of formula —Si(R^{e}R^{f}R^{g}), where each of R^{e}, R^{f}, and R^{g} is independently a hydrogen or an alkyl, as defined herein. In some embodiments, the silyl is a functional group of formula —SiH₃. In some embodiments, the silyl is a functional group of formula —SiReH₂, where R^{e} is not hydrogen. In some embodiments, the silyl is a functional group of formula —SiR^{e}R^{f}H, where R^{e} and R^{f} are not hydrogen. In some embodiments, the silyl is a functional group of the formula —Si(R^{e}R^{f}R^{g}), where R^{e}, R^{f}, and R^{g} are not hydrogen. In some embodiments, the silyl is a functional group of formula —Si(CH₃)₃ (e.g., trimethylsilyl).

As used herein, the term “alkoxyalkyl” refers to an alkyl as defined herein, wherein at least one of the hydrogen atoms of the alkyl is replaced with an alkoxy as defined herein. In some embodiments, the term “alkoxyalkyl” refers to a functional group of formula -(alkyl)OR^{a}, wherein the alkyl is defined above and wherein the R^{a} is defined above. In some embodiments, the alkoxyalkyl is a functional group of formula —(CH₂)ₙOR^{a}, where n is 1 to 10 and R^{a} is defined above. In some embodiments, the alkoxyalkyl is a functional group of the formula —CH₂CH₂OCH₃.

As used herein, the term “aralkyl” refers to an alkyl as defined herein, wherein at least one of the hydrogen atoms of the alkyl is replaced with an aryl as defined herein. In some embodiments, the term “aralkyl” refers to a functional group of formula -(alkyl) (aryl), wherein the alkyl is defined herein and the aryl is defined herein. In some embodiments, the aralkyl is-CH₂ (C₆H₅).

As used herein, the term “aminoalkyl” refers to an alkyl as defined herein, wherein at least one of the hydrogen atoms of the alkyl is replaced with an amino as defined herein. In some embodiments, the term “aminoalkyl” refers to a functional group of formula -(alkyl)N(R^{a}R^{b}), wherein the alkyl is defined above and wherein R^{a} and R^{b} are defined above. In some embodiments, the aminoalkyl is-CH₂N(CH₃)₂. In some embodiments, the aminoalkyl is —(CH₂)₃N(CH₃)₂. In some embodiments, the aminoalkyl is aminomethyl (—CH₂NH₂). In some embodiments, the aminoalkyl is N,N-dimethylaminoethyl (—CH₂CH₂N(CH₃)₂). In some embodiments, the aminoalkyl is 3-(N-cyclopropylamino) propyl (—CH₂CH₂CH₂NH—Pr).

As used herein, the term “silylalkyl” refers to an alkyl as defined herein, wherein at least one of the hydrogen atoms of the alkyl is replaced with a silyl as defined herein. In some embodiments, the term “silylalkyl” refers to a functional group of formula -(alkyl)Si(R^{e}R^{f}R^{g}), wherein the alkyl is defined above and wherein R^{e}, R^{f}, and R^{g} are defined above. In some embodiments, the silylalky is a functional group of formula —(CH₂)ₘSi(R^{e}R^{f}R^{g}), where m is 1 to 10 and where R^{e}, R^{f}, and R^{g} are defined above. In some embodiments, the silylalkyl is a functional group of formula —CH₂Si(CH₃)₃.

As used herein, the term “haloalkyl” refers to an alkyl as defined here, wherein at least one of the hydrogen atoms of the alkyl is replaced with a halide as defined herein. In some embodiments, the haloalkyl comprises a fluoroalkyl. In some embodiments, the fluoroalkyl comprises at least one of —CH₂CF₃, —CH(CF₃)₂, —CH₂F, —CH₂CH₂F, —CF₃, —CF₂CF₃, or any combination thereof.

As used herein, the term “halide” refers to a —Cl, —Br, —I, or —F.

As used herein, the term “metal cation” refers to at least one of a alkali metal cation, an alkaline earth metal cation, a transition metal cation, a post-transition metal cation, or any combination thereof. In some embodiments, the metal cation comprises a lithium cation, a sodium cation, a potassium cation, a rubidium cation, a cesium cation, a francium cation, a beryllium cation, a magnesium cation, a calcium cation, a strontium cation, a barium cation, a radium cation, a scandium cation, a titanium cation, a vanadium cation, a chromium cation, a manganese cation, an iron cation, a cobalt cation, a nickel cation, a copper cation, a zinc cation, a yttrium cation, a zirconium cation, a niobium cation, a molybdenum cation, a technetium cation, a ruthenium cation, a rhodium cation, a palladium cation, a silver cation, a cadmium cation, a hafnium cation, a tantalum cation, a tungsten cation, a rhenium cation, an osmium cation, an iridium cation, a platinum cation, a gold cation, a mercury cation, an aluminum cation, a gallium cation, an indium cation, tin cation, a thallium cation, a lead cation, a bismuth cation, or a polonium cation. The charge(s) of the metal cations are known and, for simplicity, thus are not repeated here; however, it will be appreciated that the metal cations can have any known charge. For example, in some embodiments, the metal cation comprises Li⁺, Na⁺, K⁺, Rb⁺, Cs⁺, Mg²⁺, Ca²⁺, Sr²⁺, Ba²⁺, or Zn²⁺. In some embodiments, the metal cation is Sn(II) or Sn(IV). In some embodiments, the metal is Ti, Zr, or Hf.

Some embodiments relate to compositions and related systems and methods. In some embodiments, the compositions are useful in extreme-ultraviolet (EUV) lithography, among other applications, and related methods. The compositions disclosed herein include at least one of a tin (IV) amide compound, a metal alkoxide compound, or any combination thereof. The tin (IV) amide compounds may be used to form tin-containing films useful in the fabrication of microelectronic devices, including semiconductor devices. For example, the compositions may be used as precursors to form functionalized tin oxide films (RSnOₓ). The functionalized tin oxide films may be used in dry resist applications or as reflective coatings for extreme-ultraviolet (EUV) lithography, among others. The compositions may be formed according to the methods disclosed herein in high yield and high purity (i.e., with low levels of impurities, undesirable byproducts, and the like) while also minimizing the number of steps required to produce the precursor compositions.

The tin-containing films may also be formed according to the methods disclosed herein. That is, the tin-containing films disclosed herein may be formed by one or more deposition processes that utilize the precursor compositions. Examples of deposition processes include, without limitation, at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

The methods of synthesis disclosed herein provide a synthetic route for the preparation of tin (IV) amide compounds, such as, for example and without limitation, monoalkyl tin amide compounds (and/or metal alkoxide compounds), from alkoxy derivatives. The synthetic route can produce tin (IV) amide compounds that cannot be produced using conventional routes. In addition, the synthetic route is simpler that conventional routes, without the need for harsh conditions to separate products and without the challenge of separating products from other species with similar boiling points. In some embodiments, the method of synthesis uses early transition metal compounds (e.g., early transition metal amines) to install the amide group(s) on tin. In some embodiments, the tin (IV) amide compounds are useful as precursors in vapor deposition processes. In some embodiments, the metal alkoxide compounds are useful as precursors in vapor deposition processes. In some embodiments, as both the tin (IV) amide compounds and the metal alkoxide compounds are both useful as precursors, the methods of synthesis disclosed herein produce less waste.

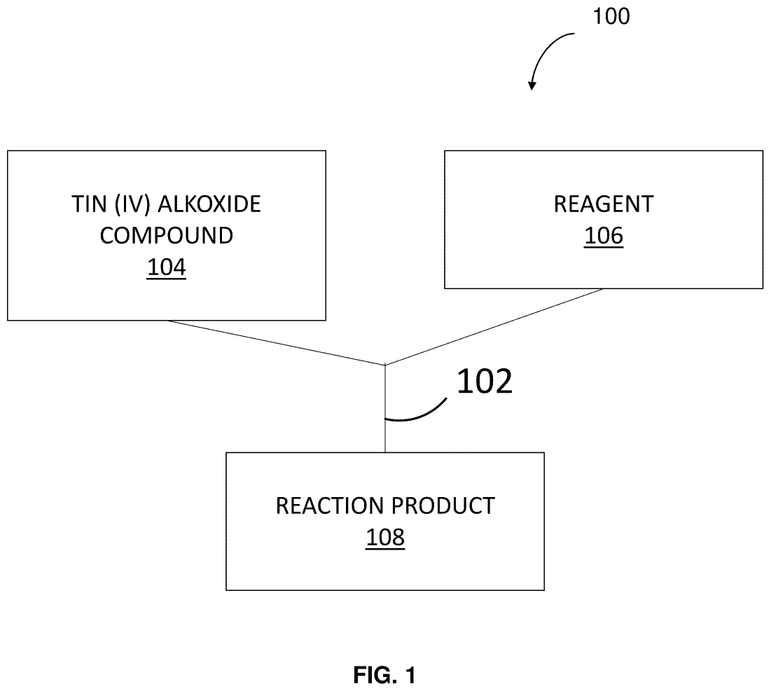

FIG. 1 is a flowchart of a method of synthesis 100, according to some embodiments. As shown in FIG. 1, in some embodiments, the method of synthesis 100 comprises contacting 102 a tin (IV) alkoxide compound 104 with a reagent 106 to form at least one reaction product 108.

In some embodiments, the contacting 102 comprises bringing the tin (IV) alkoxide compound 104 and the metal amide compound 106 into immediate or close proximity. In some embodiments, the contacting 102 comprises bringing the tin (IV) alkoxide compound 104 and the metal amide compound 106 into direct physical contact. In some embodiments, the contacting 102 comprises mixing or stirring the tin (IV) alkoxide compound 104 and the metal amide compound 106. In some embodiments, the contacting 102 comprises agitating the tin (IV) alkoxide compound 104 and the metal amide compound 106. In some embodiments, the contacting 102 comprises reacting the tin (IV) alkoxide compound 104 with the metal amide compound 106. In some embodiments, the contacting 102 comprises adding or combining the tin (IV) alkoxide compound 104 and the metal amide compound 106 to a reaction vessel. In some embodiments, the contacting 102 comprises dissolving at least one of the tin (IV) alkoxide compound 104, the metal amide compound 106, or any combination thereof, in at least one of a solution, a solvent, or a reaction medium. In some embodiments, the contacting 102 comprises dissolving the tin (IV) alkoxide compound 104 in a first solution, dissolving the metal amide compound 106 in a second solution, and combining the first solution and the second solution in a reaction vessel. In some embodiments, the contacting 102 comprises dissolving the tin (IV) alkoxide compound 104 in a first solution, and combining the first solution and the metal amide compound 106 in a reaction vessel. In some embodiments, the contacting 102 comprises dissolving the metal amide compound 106 in a second solution and combining the tin (IV) alkoxide compound 104 and the second solution in a reaction vessel.

In some embodiments, at least 0.25 equivalents of the metal amide compound 106 are contacted with the tin (IV) alkoxide compound 104. In some embodiments, at least 0.5, 0.75, 1, 1.25, 1.5, 1.75, or 2 equivalents of the metal amide compound 106 are contacted with the tin (IV) alkoxide compound 104. In some embodiments, 0.25 to 2 equivalents, 0.5 to 2 equivalents, 0.75 to 2 equivalents, 1 to 2 equivalents, to 2 equivalents, 1.25 to 2 equivalents, 1.5 to 2 equivalents, 1.75 to 2 equivalents, 0.25 to 1.75 equivalents, 0.25 to 1.5 equivalents, 0.25 to 1.25 equivalents, 0.25 to 1 equivalents, 0.25 to 0.75 equivalents, or 0.25 to 0.5 equivalents of the metal amide compound 106 are contacted with the tin (IV) alkoxide compound 104.

In some embodiments, the tin (IV) alkoxide compound 104 comprises a compound of the formula:

RₙSn(Q)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, the tin (IV) alkoxide compound 104 comprises a compound of the formula:

RₙSn(OR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
In some embodiments, the tin (IV) alkoxide compound 104 comprises a compound of the formula:
n is 0, 1, 2, or 3.

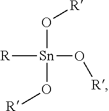

where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof; and
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, R comprises at least one of an unsaturated alkyl, a saturated alkyl, a linear alkyl, a branched alkyl, a fluoroalkyl, a halogen, an oxygen, a nitrogen, a silicon, or any combination thereof. In some embodiments, R is an unsaturated alkyl. In some embodiments, R is a saturated alkyl. In some embodiments, R is a linear alkyl. In some embodiments, R is a branched alkyl. In some embodiments, R is a fluoroalkyl. In some embodiments, the fluoroalkyl is at least one of —CH₂CF₃, —CH(CF₃)₂, —CH₂F, —CH₂CH₂F, —CF₃, —CF₂CF₃, or any combination thereof.

In some embodiments, the tin (IV) alkoxide compound is a compound of the formula:

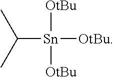 [SMILES: C[CH](C)[Sn]([O]C(C)(C)C)([O]C(C)(C)C)[O]C(C)(C)C]

In some embodiments, the tin (IV) alkoxide compound is a compound of the

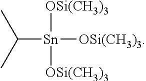

In some embodiments, the tin (IV) alkoxide compound is a compound of the formula:

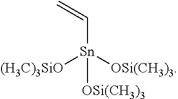

In some embodiments, the tin (IV) compound comprises a tin (IV) carboxylate compound of the formula:

RₙSn(O₂CR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R′ is independently at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, R is a C₁-C₆ alkyl.

In some embodiments, R′ is independently a hydrogen, a C₁-C₆ alkyl, or a phenyl.

In some embodiments, R′ is independently —H, —CH₃, —CH₂CH₃, —CH₂CH₂CH₃, or -(phenyl).

In some embodiments, the tin (IV) compound comprises a tin (IV) carboxylate compound of the formula:

RₙSn(O₂CR′)₄₋ₙ,
where:
R is an isopropyl;
R′ is a methyl; and
n is 1.

In some embodiments, the tin (IV) compound comprises a tin (IV) carboxylate compound of the formula:

RₙSn(O₂CR′)₄₋ₙ,
where:
R is an isopropyl;
R′ is a phenyl; and
n is 1.

In some embodiments, the tin (IV) compound comprises a tin (IV) halide compound of the formula:

RₙSn(halide)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
halide is Cl, Br, or I; and
n is 0 to 3.

In some embodiments, R is a C₁-C₆ alkyl.

In some embodiments, the tin (IV) compound comprises a tin (IV) halide compound of the formula:

RₙSn(halide)₄₋ₙ,
R is an isopropyl;
halide is Cl, Br, or I; and
n is 1.

In some embodiments, the tin (IV) compound comprises a tin (IV) halide compound of the formula:

RₙSn(halide)₄₋ₙ,
where:
R is an isopropenyl;
halide is Cl, Br, or I; and
n is 1.

In some embodiments, the reagent 106 comprises at least one of a metal alkoxide compound, a metal amide compound, or any combination thereof.

In some embodiments, the metal amide compound comprises a compound of the formula:

M(NR″₂)ₐX_{b},
where:
M is an alkali metal cation, an alkaline earth metal cation, a transition metal cation, or a post-transition metal cation;
R″ is independently a hydrogen, an alkyl, a cycloalkyl, an aryl, or a silyl, or are bonded to each other to form a C₃-C₂₀ N-heterocycle;
X is independently a cyclopentadienyl, an indenyl, a chloro, a bromo, an iodo, or a fluoro; and

a+b=2, 3, 4, or 5.

In some embodiments, the metal amide compound is a compound of the

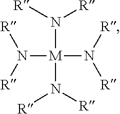

where:
M is Ti, Zr, or Hf; and
R″ is independently a hydrogen, an alkyl, a cycloalkyl, an aryl, or a silyl, or are bonded to each other to form a C₅-C₂₀ N-heterocycle.

In some embodiments, the metal amide compound is a compound of the formula:

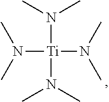

In some embodiments, the metal amide compound is a compound of the formula:

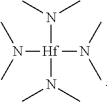

In some embodiments, the metal amide compound is a compound of the

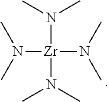

In some embodiments, the metal amide compound is a compound of the formula:

M(NR″₂),
where:
M is a lithium, a sodium, or a magnesium;
R″ is independently a C₁-C₆ alkyl.

In some embodiments, the metal amide compound comprises a compound of the formula:

M(NR″₂),
where:
M is a lithium (Li);
R″ is a methyl.

In some embodiments, the metal amide compound comprises a compound of the formula:

[M(NR″₂)₂]ₙ,
where:
M is an alkali metal cation, an alkaline earth metal cation, a transition metal cation, or a post-transition metal cation;
R″ is independently a hydrogen, an alkyl, a cycloalkyl, an aryl, or a silyl, or are bonded to each other to form a C₃-C₂₀ N-heterocycle; and
n is 1 or 2.

In some embodiments, the metal amide compound comprises a compound of the formula:

[Sn(NR″₂)₂]ₙ,
where:
R″ is independently a hydrogen, an alkyl, a cycloalkyl, an aryl, or a silyl, or
are bonded to each other to form a C₃-C₂₀ N-heterocycle; and
n is 1 or 2.

In some embodiments, the metal amide compound comprises a compound of the formula:

[Sn(NR″₂)₂]ₙ,
where:
R″ is a C₁-C₆ alkyl; and
n is 2.

In some embodiments, the metal amide compound comprises a compound of the formula:

[Sn(NR″₂)₂]ₙ,
where:
R″ is a methyl; and
n is 2.

In some embodiments, the metal alkoxide compound comprises a compound of the formula:

M(OR″)ₙ,
M is an alkali metal cation, an alkaline earth metal cation, a transition metal cation, or a post-transition metal cation;
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 1 to 5.

In some embodiments, the metal alkoxide compound comprises a compound of the formula:

M(OR″)ₙ,
where:
M is an alkali metal cation or an alkaline earth metal cation;
R″ is independently a C₁-C₆ alkyl; and
n is 1 or 2.

In some embodiments, the metal alkoxide compound comprises a compound of the formula:

M(OR″)ₙ,
where:
M is a sodium, a lithium, or a magnesium;
R″ is independently a C₁-C₆ alkyl; and
n is 1 or 2.

In some embodiments, the metal alkoxide compound comprises a compound of the formula:

M(OR″)ₙ,
M is a sodium (Na);
R″ is a tert-butyl; and
n is 1.

In some embodiments, the metal alkoxide compound comprises a compound of the formula:

[M(OR″)₂]ₙ,
where:
M is an alkali metal cation, an alkaline earth metal cation, a transition metal cation, or a post-transition metal cation;
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 1 or 2.

In some embodiments, the metal alkoxide compound comprises a compound of the formula:

[Sn(OR″)₂]ₙ,
where:
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 1 or 2.

In some embodiments, the metal alkoxide compound comprises a compound of the formula:

[Sn(OR″)₂]ₙ,
where:
R″ is a tert-butyl; and
n is 2.

In some embodiments, the at least one reaction product comprises a tin (IV) amide compound of the formula:

RₙSn(NR″₂)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is independently a hydrogen, an alkyl, a cycloalkyl, an aryl, or a silyl, or are bonded to each other to form a C₃-C₂₀ N-heterocycle; and
n is 0, 1, 2, or 3.

In some embodiments, the at least one reaction product comprises a tin (IV) amide compound of the formula:

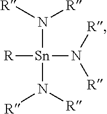

where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof; and
R″ is independently a hydrogen, an alkyl, a cycloalkyl, an aryl, or a silyl, or are bonded to each other to form a C₃-C₂₀ N-heterocycle.

In some embodiments, R comprises at least one of an unsaturated alkyl, a saturated alkyl, a linear alkyl, a branched alkyl, a fluoroalkyl, a halogen, an oxygen, a nitrogen, a silicon, or any combination thereof. In some embodiments, R is an unsaturated alkyl. In some embodiments, R is a saturated alkyl. In some embodiments, R is a linear alkyl. In some embodiments, R is a branched alkyl. In some embodiments, R is a fluoroalkyl. In some embodiments, the fluoroalkyl is at least one of —CH₂CF₃, —CH(CF₃)₂, —CH₂F, —CH₂CH₂F, —CF₃, —CF₂CF₃, or any combination thereof.

In some embodiments, the at least one reaction product comprises a tin (IV) amide compound of formula:

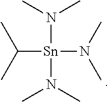

In some embodiments, the at least one reaction product comprises a tin (IV) amide compound of formula:

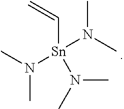

In some embodiments, the at least one reaction product comprises a metal alkoxide compound of the formula:

M(OR′)_{q},
where:
M is an alkali metal cation, an alkaline earth metal cation, a transition metal cation, or a post-transition metal cation;
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
q is 2, 3, 4, or 5.

In some embodiments, the at least one reaction product comprises a metal alkoxide compound of the formula:

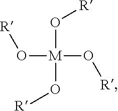

where:
M is a transition metal cation or a post-transition metal cation; and
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, the at least one reaction product comprises a metal alkoxide compound the formula:

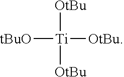

In some embodiments, the at least one reaction product comprises a metal alkoxide compound the formula:

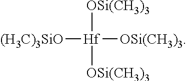

In some embodiments, the at least one reaction product comprises a metal alkoxide compound the formula:

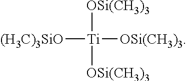

In some embodiments, the at least one reaction product comprises a tin (IV) amide compound of the formula:

RₙSn(NR″₂)₄₋ₙ,
where:
R is a C₁-C₆ alkyl;
R″ is a C₁-C₆ alkyl; and
n is 1.

In some embodiments, the at least one reaction product comprises a tin (IV) amide compound of the formula:

RₙSn(NR″₂)₄₋ₙ,
R is an isopropyl;
R″ is a methyl; and
n is 1.

In some embodiments, the at least one reaction product comprises a tin (IV) amide compound of the formula:

RₙSn(NR″₂)₄₋ₙ,
where:
R is an isopropenyl;
R″ is a methyl; and
n is 1.

In some embodiments, the tin (IV) compound comprises a tin (IV) halide compound of the formula:

RₙSn(halide)₄₋ₙ,
where:
R is an isopropyl;
halide is Cl, Br, or I; and
n is 1;
the metal amide compound comprises a compound of the formula:

[Sn(NR″₂)₂]ₙ,
where:
R″ is a methyl; and
n is 2;
the at least one reaction product comprises a tin (IV) amide compound of the formula:

RₙSn(NR″₂)₄₋ₙ,
where:
R is an isopropyl;
R″ is a methyl; and
n is 1.

In some embodiments, the tin (IV) compound comprises a tin (IV) carboxylate compound of the formula:

RₙSn(O₂CR′)₄₋ₙ,
where:
R is an isopropyl;
R′ is a methyl; and
n is 1;
the metal amide compound comprises a compound of the formula:

[Sn(NR″₂)₂]ₙ,
where:
R″ is a methyl; and
n is 2;
the at least one reaction product comprises a tin (IV) amide compound of the formula:

RₙSn(NR″₂)₄₋ₙ,
where:
R is an isopropyl;
R″ is a methyl; and
n is 1.

In some embodiments, the tin (IV) compound comprises a tin (IV) carboxylate compound of the formula:

RₙSn(O₂CR′)₄₋ₙ,
where:
R is an isopropyl;
R′ is a methyl; and
n is 1;
the metal amide compound comprises a compound of the formula:

M(NR″₂),
where:
M is a lithium (Li);
R″ is a methyl;
the at least one reaction product comprises a tin (IV) amide compound of the formula:

RₙSn(NR″₂)₄₋ₙ,
where:
R is an isopropyl;
R″ is a methyl; and
n is 1.

In some embodiments, the tin (IV) compound comprises a tin (IV) carboxylate compound of the formula:

RₙSn(O₂CR′)₄₋ₙ,
where:
R is an isopropyl;
R′ is a methyl; and
n is 1;
the metal alkoxide compound comprises a compound of the formula:

M(OR″)ₙ,
where:
M is a sodium (Na);
R″ is a tert-butyl; and
n is 1;
the at least one reaction product comprises a tin (IV) alkoxide compound of the formula:

RₙSn(OR″)₄₋ₙ,
where:
R is an isopropyl;
R″ is a tert-butyl; and
n is 1.

In some embodiments, the tin (IV) compound comprises a tin (IV) carboxylate compound of the formula:

RₙSn(O₂CR′)₄₋ₙ,
where:
R is an isopropyl;
R′ is a methyl; and
n is 1;
the metal alkoxide compound comprises a compound of the formula:

[Sn(OR″)₂]ₙ,
where:
R″ is a tert-butyl; and
n is 2;
the at least one reaction product comprises a tin (IV) alkoxide compound of the formula:

RₙSn(OR″)₄₋ₙ,
where:
R is an isopropyl;
R″ is a tert-butyl; and
n is 1.

In some embodiments, the tin (IV) compound comprises a tin IV carboxylate compound of the formula:

RₙSn(O₂CR′)₄₋ₙ,
where:
R is an isopropyl;
R′ is a phenyl; and
n is 1;
the metal amide compound comprises a compound of the formula:

[Sn(NR″₂)₂]ₙ,
where:
R″ is a methyl; and
n is 2;
the at least one reaction product comprises a tin (IV) amide compound of the formula:

RₙSn(NR″₂)₄₋ₙ,
where:
R is an isopropyl;
R″ is a methyl; and
n is 1.

In some embodiments, the tin (IV) compound comprises a tin IV halide compound of the formula:

RₙSn(halide)₄₋ₙ,
where:
R is an isopropenyl;
halide is Cl, Br, or I; and
n is 1;
the metal amide compound comprises a compound of the formula:

[Sn(NR″₂)₂]ₙ,
where:
R″ is a methyl; and
n is 2;
the at least one reaction product comprises a tin (IV) amide compound of the formula:

RₙSn(NR″₂)₄₋ₙ,
where:
R is an isopropenyl;
R″ is a methyl; and
n is 1.

In some embodiments, the at least one reaction product comprises a tin (IV) alkoxide compound of the formula:

RₙSn(OR″)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 0 to 3.

In some embodiments, the at least one reaction product comprises a tin (IV) alkoxide compound of the formula:

RₙSn(OR″)₄₋ₙ,
where:
R is a C₁-C₆ alkyl;
R″ is a C₁-C₆ alkyl; and
n is 1.

In some embodiments, the at least one reaction product comprises a tin (IV) alkoxide compound of the formula:

RₙSn(OR″)₄₋ₙ,
where:
R is an isopropyl;
R″ is a tert-butyl; and
n is 1.

(RSnX₃+M(OR)ₙ→RSn(OR)₃)

In some embodiments, the method comprises contacting a tin (IV) compound with a metal alkoxide compound to form at least one reaction product.

In some embodiments, the tin (IV) compound comprises a compound of the formula:

RₙSn(Q)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, the metal alkoxide compound comprises a compound of the formula:

M(OR″)ₙ,
where:
M is an alkali metal cation, an alkaline earth metal cation, a transition metal cation, or a post-transition metal cation;
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 1 to 5.

In some embodiments, the tin (IV) compound comprises a tin (IV) alkoxide compound of the formula:

RₙSn(OR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, the tin (IV) compound comprises a tin (IV) carboxylate compound of the formula:

RₙSn(O₂CR′)₄₋₁,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R′ is independently at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, R is a C₁-C₆ alkyl.

In some embodiments, R′ is independently a hydrogen, a C₁-C₆ alkyl, or a phenyl.

In some embodiments, R′ is independently —H, —CH₃, —CH₂CH₃, —CH₂CH₂CH₃, or -(phenyl).

In some embodiments, the tin (IV) compound comprises a tin (IV) halide compound of the formula:

RₙSn(halide)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
halide is Cl, Br, or I; and
n is 0 to 3.

In some embodiments, R is a C₁-C₆ alkyl.

In some embodiments, the metal alkoxide compound comprises a compound of the formula:

M(OR″)ₙ,
M is an alkali metal cation or an alkaline earth metal cation;
R″ is independently a C₁-C₆ alkyl; and
n is 1 or 2.

In some embodiments, the metal alkoxide compound comprises a compound of the formula:

M(OR″)ₙ,
where:
M is a sodium, a lithium, or a magnesium;
R″ is independently a C₁-C₆ alkyl; and
n is 1 or 2.

In some embodiments, the metal alkoxide compound comprises a compound of the formula:

M(OR″)ₙ,
where:
M is a sodium (Na);
R″ is a tert-butyl; and
n is 1.

In some embodiments, the at least one reaction product comprises a tin (IV) alkoxide compound of the formula:

RₙSn(OR″)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 0 to 3.

In some embodiments, the tin (IV) compound comprises a tin (IV) carboxylate compound of the formula:

RₙSn(O₂CR′)₄₋ₙ,
where:
R is an isopropyl;
R′ is a methyl; and
n is 1;
the metal alkoxide compound comprises a compound of the formula:

M(OR″)ₙ,
where:
M is a sodium (Na);
R″ is a tert-butyl; and
n is 1;
the at least one reaction product comprises a tin (IV) alkoxide compound of the formula:

RₙSn(OR″)₄₋ₙ,
where:
R is an isopropyl;
R″ is a tert-butyl; and
n is 1.

(RSnX₃+[Sn(OR)₂]ₙ→RSn(OR)₃)

In some embodiments, the method comprises contacting a tin (IV) compound with a metal alkoxide compound to form at least one reaction product.

In some embodiments, the tin (IV) compound comprises a compound of the formula:

RₙSn(Q)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, the metal alkoxide compound comprises a compound of the formula:

[M(OR″)₂]ₙ,
where:
M is an alkali metal cation, an alkaline earth metal cation, a transition metal cation, or a post-transition metal cation;
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 1 or 2.

In some embodiments, the tin (IV) compound comprises a tin (IV) alkoxide compound of the formula:

RₙSn(OR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, the tin (IV) compound comprises a tin (IV) carboxylate compound of the formula:

RₙSn(O₂CR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R′ is independently at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, R is a C₁-C₆ alkyl.

In some embodiments, R′ is independently a hydrogen, a C₁-C₆ alkyl, or a phenyl.

In some embodiments, R′ is independently —H, —CH₃, —CH₂CH₃, —CH₂CH₂CH₃, or -(phenyl).

In some embodiments, wherein the tin (IV) compound comprises a tin (IV) halide compound of the formula:

RₙSn(halide)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
halide is Cl, Br, or I; and
n is 0 to 3.

In some embodiments, R is a C₁-C₆ alkyl.

In some embodiments, the metal alkoxide compound comprises a compound of the formula:

[Sn(OR″)₂]ₙ,
where:
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 1 or 2.

In some embodiments, the metal alkoxide compound comprises a compound of the formula:

[Sn(OR″)₂]ₙ,
where:
R″ is a tert-butyl; and
n is 2.

In some embodiments, the at least one reaction product comprises a tin (IV) alkoxide compound of the formula:

RₙSn(OR″)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 0 to 3.

In some embodiments, the tin (IV) compound comprises a tin (IV) carboxylate compound of the formula:

RₙSn(O₂CR′)₄₋ₙ,
R is an isopropyl;
R′ is a methyl; and
n is 1;
the metal alkoxide compound comprises a compound of the formula:

[Sn(OR″)₂]ₙ,
where:
R″ is a tert-butyl; and
n is 2;
the at least one reaction product comprises a tin (IV) alkoxide compound of the formula:

RₙSn(OR″)₄₋ₙ,
where:
R is an isopropyl;
R″ is a tert-butyl; and
n is 1.

(RSnX₃+M(NR₂)ₙ→RSn(NR₂)₃)

In some embodiments, the method comprises contacting a tin (IV) compound with a metal amide compound to form at least one reaction product.

In some embodiments, the tin (IV) compound comprises a compound of the formula:

RₙSn(Q)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, the metal amide compound comprises a compound of the formula:

M(NR″₂)ₐX_{b},
where:
M is an alkali metal cation, an alkaline earth metal cation, a transition metal cation, or a post-transition metal cation;
R″ is independently a hydrogen, an alkyl, a cycloalkyl, an aryl, or a silyl, or are bonded to each other to form a C₃-C₂₀ N-heterocycle;
X is independently a cyclopentadienyl, an indenyl, a chloro, a bromo, an iodo, or a fluoro; and

a+b=2 to 5.

In some embodiments, the tin (IV) compound comprises a tin (IV) alkoxide compound of the formula:

RₙSn(OR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, the tin (IV) compound comprises a tin (IV) carboxylate compound of the formula:

RₙSn(O₂CR′)₄₋ₙ,
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R′ is independently at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, R is a C₁-C₆ alkyl.

In some embodiments, R′ is independently a hydrogen, a C₁-C₆ alkyl, or a phenyl.

In some embodiments, R′ is independently —H, —CH₃, —CH₂CH₃, —CH₂CH₂CH₃, or -(phenyl).

In some embodiments, the tin (IV) compound comprises a tin (IV) halide compound of the formula:

RₙSn(halide)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
halide is Cl, Br, or I; and
n is 0 to 3.

In some embodiments, R is a C₁-C₆ alkyl.

In some embodiments, the metal amide compound comprises a compound of the formula:

M(NR″₂),
M is an alkali metal cation or an alkaline earth metal cation;
R″ is independently a C₁-C₆ alkyl.

In some embodiments, the metal amide compound comprises a compound of the formula:

M(NR″₂),
where:
M is a lithium, a sodium, or a magnesium;
R″ is independently a C₁-C₆ alkyl.

In some embodiments, the metal amide compound comprises a compound of the formula:

M(NR″₂),
where:
M is a lithium (Li);
R″ is a methyl.

In some embodiments, the at least one reaction product comprises a tin (IV) amide compound of the formula:

RₙSn(NR″₂)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is independently a hydrogen, an alkyl, a cycloalkyl, an aryl, or a silyl, or are bonded to each other to form a C₃-C₂₀ N-heterocycle; and
n is 0 to 3.

In some embodiments, the tin (IV) compound comprises a tin (IV) carboxylate compound of the formula:

RₙSn(O₂CR′)₄₋ₙ,
where:
R is an isopropyl;
R′ is a methyl; and
n is 1;
the metal amide compound comprises a compound of the formula:

M(NR″₂),
where:
M is a lithium (Li);
R″ is a methyl;
the at least one reaction product comprises a tin (IV) amide compound of the formula:

RₙSn(NR″₂)₄₋ₙ,
where:
R is an isopropyl;
R″ is a methyl; and
n is 1.

(RSnX₃+[Sn(NR₂)₂]ₙ→RSn(NR₂)₃)

In some embodiments, the method comprises contacting a tin (IV) compound with a reagent to form at least one reaction product.

In some embodiments, the tin (IV) compound comprises a compound of the formula:

RₙSn(Q)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, the metal amide compound comprises a compound of the formula:

[M(NR″₂)₂]ₙ,
where:
M is an alkali metal cation, an alkaline earth metal cation, a transition metal cation, or a post-transition metal cation;
R″ is independently a hydrogen, an alkyl, a cycloalkyl, an aryl, or a silyl, or are bonded to each other to form a C₃-C₂₀ N-heterocycle; and
n is 1 or 2.

In some embodiments, the tin (IV) compound comprises a tin (IV) alkoxide compound of the formula:

RₙSn(OR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, the tin (IV) compound comprises a tin (IV) carboxylate compound of the formula:

RₙSn(O₂CR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R′ is independently at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.

In some embodiments, R is a C₁-C₆ alkyl.

In some embodiments, R′ is independently a hydrogen, a C₁-C₆ alkyl, or a phenyl.

In some embodiments, R′ is independently —H, —CH₃, —CH₂CH₃, —CH₂CH₂CH₃, or -(phenyl).

In some embodiments, the tin (IV) compound comprises a tin (IV) halide compound of the formula:

RₙSn(halide)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
halide is Cl, Br, or I; and
n is 0 to 3.

In some embodiments, R is a C₁-C₆ alkyl.

In some embodiments, the metal amide compound comprises a compound of the formula:

[Sn(NR″₂)₂]ₙ,
where:
R″ is independently a hydrogen, an alkyl, a cycloalkyl, an aryl, or a silyl, or are bonded to each other to form a C₃-C₂₀ N-heterocycle; and
n is 1 or 2.

In some embodiments, the metal amide compound comprises a compound of the formula:

[Sn(NR″₂)₂]ₙ,
where:
R″ is a C₁-C₆ alkyl; and
n is 2.

In some embodiments, the metal amide compound comprises a compound of the formula:

[Sn(NR″₂)₂]ₙ,
where:
R″ is a methyl; and
n is 2.

In some embodiments, the at least one reaction product comprises a tin (IV) amide compound of the formula:

RₙSn(NR″₂)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is independently a hydrogen, an alkyl, a cycloalkyl, an aryl, or a silyl, or are bonded to each other to form a C₃-C₂₀ N-heterocycle; and
n is 0 to 3.

In some embodiments, the tin (IV) compound comprises a tin (IV) halide compound of the formula:

RₙSn(halide)₄₋ₙ,
where:
R is an isopropyl;
halide is Cl, Br, or I; and
n is 1;
the metal amide compound comprises a compound of the formula:

[Sn(NR″₂)₂]ₙ,
R″ is a methyl; and
n is 2;
the at least one reaction product comprises a tin (IV) amide compound of the formula:

RₙSn(NR″₂)₄₋ₙ,
where:
R is an isopropyl;
R″ is a methyl; and
n is 1.

In some embodiments, the tin (IV) compound comprises a tin (IV) carboxylate compound of the formula:

RₙSn(O₂CR′)₄₋ₙ,
where:
R is an isopropyl;
R′ is a methyl; and
n is 1;
the metal amide compound comprises a compound of the formula:

[Sn(NR″₂)₂]ₙ,
where:
R″ is a methyl; and
n is 2;
the at least one reaction product comprises a tin (IV) amide compound of the formula:

RₙSn(NR″₂)₄₋ₙ,
where:
R is an isopropyl;
R″ is a methyl; and
n is 1.

In some embodiments, the tin (IV) compound comprises a tin IV carboxylate compound of the formula:

RₙSn(O₂CR′)₄₋ₙ,
where:
R is an isopropyl;
R′ is a phenyl; and
n is 1;
the metal amide compound comprises a compound of the formula:

[Sn(NR″₂)₂]ₙ,
where:
R″ is a methyl; and
n is 2;
the at least one reaction product comprises a tin (IV) amide compound of the formula:

RₙSn(NR″₂)₄₋ₙ,
where:
R is an isopropyl;
R″ is a methyl; and
n is 1.

In some embodiments, the tin (IV) compound comprises a tin IV halide compound of the formula:

RₙSn(halide)₄₋ₙ,
where:
R is an isopropenyl;
halide is Cl, Br, or I; and
n is 1;
the metal amide compound comprises a compound of the formula:

[Sn(NR″₂)₂]ₙ,
where:
R″ is a methyl; and
n is 2;
the at least one reaction product comprises a tin (IV) amide compound of the formula:

RₙSn(NR″₂)₄₋ₙ,
where:
R is an isopropenyl;
R″ is a methyl; and
n is 1.

Some embodiments relate to a composition. In some embodiments, the composition comprises a tin (IV) carboxylate compound of the formula:

RₙSn(O₂CR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R′ is at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3.
R is independently a C₁-C₆ alkyl.
R′ is independently a C₁-C₆ alkyl.
R′ is independently a methyl or a phenyl.

In some embodiments, a purity of the tin (IV) carboxylate compound is at least 95%. In some embodiments, a purity of the tin (IV) carboxylate compound is 95% to 99.9999%, 95.5% to 99.9999%, 96% to 99.9999%, 96.5% to 99.9999%, 97% to 99.9999%, 97.5% to 99.9999%, 98% to 99.9999%, 98.5% to 99.9999%, 99% to 99.9999%, 99.5% to 99.9999%, 99.9% to 99.9999%, 99.99% to 99.9999%, 99.999% to 99.9999%, 95% to 99.999%, 95% to 999%, 95% to 99%, 95% to 99.5%, 95% to 99%, 95% to 98.5%, 95% to 98%, 95% to 97.5%, 95% to 97%, 95% to 96.5%, 95% to 96%, or 95% to 95.5%.

Some embodiments relate to a composition. In some embodiments, the composition comprises a tin (IV) amide compound of the formula:
RₙSn(NR″₂)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is independently a hydrogen, an alkyl, a cycloalkyl, an aryl, or a silyl, or are bonded to each other to form a C₃-C₂₀ N-heterocycle; and
n is 0 to 3.

In some embodiments, R is independently a C₁-C₆ alkyl.

In some embodiments, R″ is independently a C₁-C₆ alkyl.

In some embodiments, a purity of the tin (IV) amide compound is at least 95%. In some embodiments, a purity of the tin (IV) amide compound is 95% to 99.9999%, 95.5% to 99.9999%, 96% to 99.9999%, 96.5% to 99.9999%, 97% to 99.9999%, 97.5% to 99.9999%, 98% to 99.9999%, 98.5% to 99.9999%, 99% to 99.9999%, 99.5% to 99.9999%, 99.9% to 99.9999%, 99.99% to 99.9999%, 99.999% to 99.9999%, 95% to 99.999%, 95% to 999%, 95% to 99%, 95% to 99.5%, 95% to 99%, 95% to 98.5%, 95% to 98%, 95% to 97.5%, 95% to 97%, 95% to 96.5%, 95% to 96%, or 95% to 95.5%.

Some embodiments relate to a composition. In some embodiments, the composition comprises a tin (IV) alkoxide compound of the formula:

RₙSn(OR″)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
n is 0 to 3.

In some embodiments, R is independently a C₁-C₆ alkyl.

In some embodiments, R″ is independently a C₁-C₆ alkyl.

In some embodiments, a purity of the tin (IV) alkoxide compound is at least 95%. In some embodiments, a purity of the tin (IV) alkoxide compound is 95% to 99.9999%, 95.5% to 99.9999%, 96% to 99.9999%, 96.5% to 99.9999%, 97% to 99.9999%, 97.5% to 99.9999%, 98% to 99.9999%, 98.5% to 99.9999%, 99% to 99.9999%, 99.5% to 99.9999%, 99.9% to 99.9999%, 99.99% to 99.9999%, 99.999% to 99.9999%, 95% to 99.999%, 95% to 999%, 95% to 99%, 95% to 99.5%, 95% to 99%, 95% to 98.5%, 95% to 98%, 95% to 97.5%, 95% to 97%, 95% to 96.5%, 95% to 96%, or 95% to 95.5%.

Some embodiments relate to a composition comprising a tin (IV) amide compound. In some embodiments, the tin (IV) amide compound is a compound of the formula:

RₙSn(NR″₂)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is independently a hydrogen, an alkyl, a cycloalkyl, an aryl, or a silyl, or are bonded to each other to form a C₃-C₂₀ N-heterocycle; and
n is 0, 1, 2, or 3.

In some embodiments, the tin (IV) amide compound is a compound of the

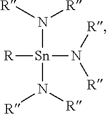

where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof; and where:
R″ is independently a hydrogen, an alkyl, a cycloalkyl, an aryl, or a silyl, or are bonded to each other to form a C₃-C₂₀ N-heterocycle.

In some embodiments, R comprises at least one of an unsaturated alkyl, a saturated alkyl, a linear alkyl, a branched alkyl, a fluoroalkyl, a halogen, an oxygen, a nitrogen, a silicon, or any combination thereof. In some embodiments, R is an unsaturated alkyl. In some embodiments, R is a saturated alkyl. In some embodiments, R is a linear alkyl. In some embodiments, R is a branched alkyl. In some embodiments, R is a fluoroalkyl. In some embodiments, the fluoroalkyl is at least one of —CH₂CF₃, —CH(CF₃)₂, —CH₂F, —CH₂CH₂F, —CF₃, —CF₂CF₃, or any combination thereof.

In some embodiments, the tin (IV) amide compound comprises a compound of the formula:

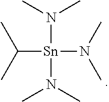

In some embodiments, the tin (IV) amide compound comprises a compound of the formula:

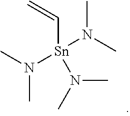

In some embodiments, the composition comprises at least 95%, at least 95.5%, at least 96%, at least 96.5%, at least 97%, at least 97.5%, at least 98%, at least 98.5%, at least 99%, at least 99.5%, at least 99.9%, at least 99.99%, at least 99.999%, at least 99.9999% by weight of the tin (IV) amide compound based on a total weight of the composition. In some embodiments, the composition comprises 95% to 99.9999%, 95.5% to 99.9999%, 96% to 99.9999%, 96.5% to 99.9999%, 97% to 99.9999%, 97.5% to 99.9999%, 98% to 99.9999%, 98.5% to 99.9999%, 99% to 99.9999%, 99.5% to 99.9999%, 99.9% to 99.9999%, 99.99% to 99.9999%, 99.999% to 99.9999%, 95% to 99.999%, 95% to 999%, 95% to 99%, 95% to 99.5%, 95% to 99%, 95% to 98.5%, 95% to 98%, 95% to 97.5%, 95% to 97%, 95% to 96.5%, 95% to 96%, or 95% to 95.5% by weight of the tin (IV) amide compound based on the total weight of the composition.

Some embodiments relate to a composition comprising a metal alkoxide compound. In some embodiments, the metal alkoxide compound is a compound of the formula:

M(OR′)_{q},
where:
M is an alkali metal cation, an alkaline earth metal cation, a transition metal cation, or a post-transition metal cation;
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, the metal alkoxide compound is a compound of the formula:

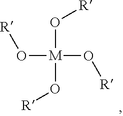

where:
M is a transition metal cation or a post-transition metal cation; and
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

In some embodiments, the metal alkoxide compound is a compound of the formula:

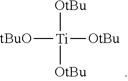

In some embodiments, the metal alkoxide compound is a compound of the formula:

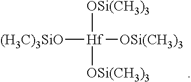

In some embodiments, the metal alkoxide compound is a compound of the formula:

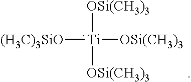

In some embodiments, the composition comprises at least 95%, at least 95.5%, at least 96%, at least 96.5%, at least 97%, at least 97.5%, at least 98%, at least 98.5%, at least 99%, at least 99.5%, at least 99.9%, at least 99.99%, at least 99.999%, at least 99.9999% by weight of the metal alkoxide compound based on a total weight of the composition. In some embodiments, the composition comprises 95% to 99.9999%, 95.5% to 99.9999%, 96% to 99.9999%, 96.5% to 99.9999%, 97% to 99.9999%, 97.5% to 99.9999%, 98% to 99.9999%, 98.5% to 99.9999%, 99% to 99.9999%, 99.5% to 99.9999%, 99.9% to 99.9999%, 99.99% to 99.9999%, 99.999% to 99.9999%, 95% to 99.999%, 95% to 999%, 95% to 99%, 95% to 99.5%, 95% to 99%, 95% to 98.5%, 95% to 98%, 95% to 97.5%, 95% to 97%, 95% to 96.5%, 95% to 96%, or 95% to 95.5% by weight of the metal alkoxide compound based on the total weight of the composition.

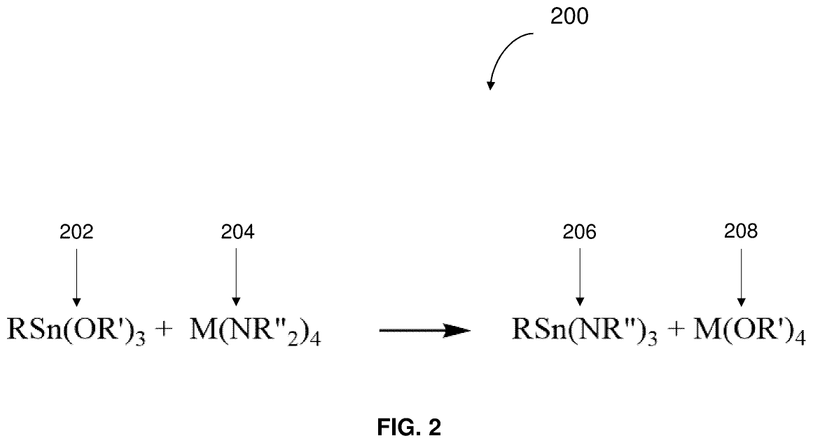

FIG. 2 is a flowchart of a method for making a tin-containing film 200, according to some embodiments. As shown in FIG. 2, the method for making a tin-containing film 200 may comprise, consist of, or consist essentially of one or more of the following steps: obtaining 202 a precursor, obtaining 204 at least one co-reactant precursor, vaporizing 206 the precursor to obtain a vaporized precursor, vaporizing 208 the at least one co-reactant precursor to obtain at least one vaporized co-reactant precursor, contacting 210 at least one of the vaporized precursor, the at least one vaporized co-reactant precursor, or any combination thereof with a substrate, under vapor deposition conditions, to form a tin-containing film on the substrate.

The step 202 may comprise, consist of, or consist essentially of obtaining a precursor. The precursor may comprise, consist of, or consist essentially of any one or more of the compositions comprising the tin (IV) amide compounds disclosed herein. The obtaining may comprise obtaining a container or other vessel comprising the precursor. In some embodiments, the precursor may be obtained in a container or other vessel in which the precursor is to be vaporized.

The step 204 may comprise, consist of, or consist essentially of obtaining at least one co-reactant precursor. In some embodiments, the at least one co-reactant precursor comprises, consists of, or consists essentially of, or is selected from the group consisting of, at least one of an oxidizing gas, a reducing gas, a hydrocarbon, or any combination thereof. The at least one co-reactant precursor may be selected to obtain a desired tin-containing film. In some embodiments, the at least one co-reactant precursor may comprise, consist of, or consist essentially of at least one of N₂, H₂, NH₃, N₂H₄, CH₃HNNH₂, CH₃HNNHCH₃, NCH₃H₂, NCH₃CH₂H₂, N(CH₃)₂H, N(CH₃CH₂)₂H, N(CH₃)₃, N(CH₃CH₂)₃, Si(CH₃)₂NH, pyrazoline, pyridine, ethylene diamine, or any combination thereof. In some embodiments, the at least one co-reactant precursor may comprise, consist of, or consist essentially of at least one of H₂, O₂, O₃, H₂O, H₂O₂, NO, N₂O, NO₂, CO, CO₂, a carboxylic acid, an alcohol, a diol, or any combination thereof. In some embodiments, the at least one co-reactant precursor comprise, consist of, or consist essentially of at least one of methane, ethane, ethylene, acetylene, or any combination thereof. The obtaining may comprise obtaining a container or other vessel comprising the at least one co-reactant precursor. In some embodiments, the at least one co-reactant precursor may be obtained in a container or other vessel in which the at least one co-reactant precursor is to be vaporized. In some embodiments, the method further comprises an inert gas, such as, for example, at least one of argon, helium, nitrogen, or any combination thereof.

The step 206 may comprise, consist of, or consist essentially of vaporizing the precursor to obtain a vaporized precursor. The vaporizing may comprise, consist of, or consist essentially of heating the precursor sufficient to obtain the vaporized precursor. In some embodiments, the vaporizing may comprise, consist of, or consist essentially of heating a container comprising the precursor. In some embodiments, the vaporizing may comprise, consist of, or consist essentially of heating the precursor in a deposition chamber in which the vapor deposition process is performed. In some embodiments, the vaporizing may comprise, consist of, or consist essentially of heating a conduit for delivering the precursor, vaporized precursor, or any combination thereof to, for example, a deposition chamber. In some embodiments, the vaporizing may comprise, consist of, or consist essentially of operating a vapor delivery system comprising the precursor. In some embodiments, the vaporizing may comprise, consist of, or consist essentially of heating to a temperature sufficient to vaporize the precursor to obtain the vaporized precursor. In some embodiments, the vaporizing may comprise, consist of, or consist essentially of heating to a temperature below a decomposition temperature of at least one of the precursor, the vaporized precursor, or any combination thereof. In some embodiments, the precursor may be present in a gas phase, in which case the step 206 is optional and not required. For example, the precursor may comprise, consist of, or consist essentially of the vaporized precursor.

The step 208 may comprise, consist of, or consist essentially of vaporizing the at least one co-reactant precursor to obtain the at least one vaporized co-reactant precursor. In some embodiments, the vaporizing may comprise, consist of, or consist essentially of heating the at least one co-reactant precursor sufficient to obtain the at least one vaporized co-reactant precursor. In some embodiments, the vaporizing may comprise, consist of, or consist essentially of heating a container comprising the at least one co-reactant precursor. In some embodiments, the vaporizing may comprise, consist of, or consist essentially of heating the at least one co-reactant precursor in a deposition chamber in which the vapor deposition process is performed. In some embodiments, the vaporizing may comprise, consist of, or consist essentially of heating a conduit for delivering the at least one co-reactant precursor, the at least one vaporized co-reactant precursor, or any combination thereof to, for example, a deposition chamber. In some embodiments, the vaporizing may comprise, consist of, or consist essentially of operating a vapor delivery system comprising the at least one co-reactant precursor. In some embodiments, the vaporizing may comprise, consist of, or consist essentially of heating to a temperature sufficient to vaporize the at least one co-reactant precursor to obtain the at least one vaporized co-reactant precursor. In some embodiments, the vaporizing may comprise, consist of, or consist essentially of heating to a temperature below a decomposition temperature of at least one of the at least one co-reactant precursor, the at least one vaporized co-reactant precursor, or any combination thereof. In some embodiments, the at least one co-reactant precursor may be present in a gas phase, in which case the step 108 is optional and not required. For example, the at least one co-reactant precursor may comprise, consist of, or consist essentially of the at least one vaporized co-reactant precursor.

The step 210 may comprise, consist of, or consist essentially of contacting at least one of the vaporized precursor, the at least one vaporized co-reactant precursor, or any combination thereof, with the substrate, under vapor deposition conditions, sufficient to form a tin-containing film on a surface of the substrate. The contacting may be performed in any system, apparatus, device, assembly, chamber thereof, or component thereof suitable for vapor deposition processes, including, for example and without limitation, a deposition chamber, among others. The vaporized precursor and the at least one co-reactant precursor may be contacted with the substrate at the same time or at different times. For example, each of the vaporized precursor, the at least one vaporized co-reactant precursor, and the substrate may be present in the deposition chamber at the same time. That is, in some embodiments, the contacting may comprise contemporaneous contacting or simultaneous contacting of the vaporized precursor and the at least one vaporized co-reactant precursor with the substrate. Alternatively, each of the vaporized precursor and the at least one vaporized co-reactant precursor may be present in the deposition chamber at different times. That is, in some embodiments, the contacting may comprise alternate and/or sequential contacting, in one or more cycles, of the vaporized precursor with the substrate and subsequently contacting the at least one vaporized co-reactant precursor with the substrate.

The vapor deposition conditions may comprise conditions for vapor deposition processes. Examples of vapor deposition conditions include, without limitation, vapor deposition conditions for vapor deposition processes including at least one of a chemical vapor deposition (CVD) process, a digital or pulsed chemical vapor deposition process, a plasma-enhanced cyclical chemical vapor deposition process (PECCVD), a flowable chemical vapor deposition process (FCVD), an atomic layer deposition (ALD) process, a thermal atomic layer deposition, a plasma-enhanced atomic layer deposition (PEALD) process, a metal organic chemical vapor deposition (MOCVD) process, a plasma-enhanced chemical vapor deposition (PECVD) process, or any combination thereof.

The vapor deposition conditions may comprise, consist of, or consist essentially of a deposition temperature. The deposition temperature may be a temperature less than the thermal decomposition temperature of at least one of the vaporized precursor, the at least one vaporized co-reactant precursor, or any combination thereof. The deposition temperature may be sufficiently high to reduce or avoid condensation of at least one of the vaporized precursor, the at least one vaporized co-reactant precursor, or any combination thereof. In some embodiments, the substrate may be heated to the deposition temperature. In some embodiments, the chamber or other vessel in which the substrate is contacted with the vaporized precursor and the at least one vaporized co-reactant precursor is heated to the deposition temperature. In some embodiments, at least one of the vaporized precursor, the at least one vaporized co-reactant precursor, or any combination thereof may be heated to the deposition temperature.

The deposition temperature may be a temperature of 200° C. to 2500° C. In some embodiments, the deposition temperature may be a temperature of 500° C. to 700° C. For example, in some embodiments, the deposition temperature may be a temperature of 500° C. to 680° C., 500° C. to 660° C., 500° C. to 640° C., 500° C. to 620° C., 500° C. to 600° C., 500° C. to 580° C., 500° C. to 560° C., 500° C. to 540° C., 500° C. to 520° C., 520° C. to 700° C., 540° C. to 700° C., 560° C. to 700° C., 580° C. to 700° C., 600° C. to 700° C., 620° C. to 700° C., 640° C. to 700° C., 660° C. to 700° C., or 680° C. to 700° C. In other embodiments, the deposition temperature may be a temperature of greater than 200° C. to 2500° C., such as, for example and without limitation, a temperature of 400° C. to 2000, 500° C. to 2000° C., 550° C. to 2400° C., 600° C. to 2400° C., 625° C. to 2400° C., 650° C. to 2400° C., 675° C. to 2400° C., 700° C. to 2400° C., 725° C. to 2400° C., 750° C. to 2400° C., 775° C. to 2400° C., 800° C. to 2400° C., 825° C. to 2400° C., 850° C. to 2400° C., 875° C. to 2400° C., 900° C. to 2400° C., 925° C. to 2400° C., 950° C. to 2400° C., 975° C. to 2400° C., 1000° C. to 2400° C., 1025° C. to 2400° C., 1050° C. to 2400° C., 1075° C. to 2400° C., 1100° C. to 2400° C., 1200° C. to 2400° C., 1300° C. to 2400° C., 1400° C. to 2400° C., 1500° C. to 2400° C., 1600° C. to 2400° C., 1700° C. to 2400° C., 1800° C. to 2400° C., 1900° C. to 2400° C., 2000° C. to 2400° C., 2100° C. to 2400° C., 2200° C. to 2400° C., 2300° C. to 2400° C., 500° C. to 2000° C., 500° C. to 1900° C., 500° C. to 1800° C., 500° C. to 1700° C., 500° C. to 1600° C., 500° C. to 1500° C., 500° C. to 1400° C., 500° C. to 1300° C., 500° C. to 1200° C., 500° C. to 1100° C., 500° C. to 1000° C., 500° C. to 1000° C., 500° C. to 900° C., or 500° C. to 800° C.

The vapor deposition conditions may comprise, consist of, or consist essentially of a deposition pressure. In some embodiments, the deposition pressure may comprise, consist of, or consist essentially of a vapor pressure of at least one of the vaporized precursor, the at least one vaporized co-reactant precursor, or any combination thereof. In some embodiments, the deposition pressure may comprise, consist of, or consist essentially of a chamber pressure.

The deposition pressure may be a pressure of 0.001 Torr to 100 Torr. For example, in some embodiments, the deposition pressure may be a pressure of 1 Torr to 30 Torr, 1 Torr to 25 Torr, 1 Torr to 20 Torr, 1 Torr to 15 Torr, 1 Torr to 10 Torr, 5 Torr to 50 Torr, 5 Torr to 40 Torr, 5 Torr to 30 Torr, 5 Torr to 20 Torr, or 5 Torr to 15 Torr. In other embodiments, the deposition pressure may be a pressure of 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, 95 Torr to 100 Torr, 1 Torr to 95 Torr, 1 Torr to 90 Torr, 1 Torr to 85 Torr, 1 Torr to 80 Torr, 1 Torr to 75 Torr, or 1 Torr to 70 Torr. In other further embodiments, the deposition pressure may be a pressure of 1 mTorr to 100 mTorr, 1 mTorr to 90 mTorr, 1 mTorr to 80 mTorr, 1 mTorr to 70 mTorr, 1 mTorr to 60 mTorr, 1 mTorr to 50 mTorr, 1 mTorr to 40 mTorr, 1 mTorr to 30 mTorr, 1 mTorr to 20 mTorr, 1 mTorr to 10 mTorr, 100 mTorr to 300 mTorr, 150 mTorr to 300 mTorr, 200 mTorr to 300 mTorr, or 150 mTorr to 250 mTorr, or 150 mTorr to 225 mTorr.

The substrate may comprise, consist of, or consist essentially of at least one of Si, Co, Cu, AI, W, WN, WC, TIN, Mo, MOC, SiO₂, W, SiN, WCN, Al₂O₃, AlN, ZrO₂, La₂O₃, TaN, RuO₂, IrO₂, Nb₂O₃, Y₂O₃, hafnium oxide, or any combination thereof.

The tin-containing film may comprise a tin oxide or a tin oxide film. In some embodiments, the tin-containing film comprises a functionalized tin oxide. In some embodiments, the tin-containing film comprises a functionalized tin oxide of the formula: RSnO_{z}, where z is 1 to 6. In some embodiments, R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, an ether, an amine, a halide, an imide, a cyanate, a nitrile, an alkoxide, a cyclopentadienyl, or an indenyl.

Some embodiments relate to a tin-containing film on a surface of a substrate. In some embodiments, the tin-containing film comprises any film formed according to the methods disclosed herein. In some embodiments, the tin-containing film comprises any film prepared from the precursors disclosed herein.

FIG. 2 depicts a reaction scheme of a method 200 of synthesis, according to some embodiments. As shown in FIG. 2, the method 200 of synthesis comprises reacting a tin (IV) alkoxide compound 202 with a metal amide compound 204 to form at least one reaction product. In some embodiments, the at least one reaction product comprises a tin (IV) amide compound 206. In some embodiments, the at least one reaction product comprises a metal alkoxide compound 208.

In some embodiments, the method of synthesis proceeds according to the following reaction scheme:

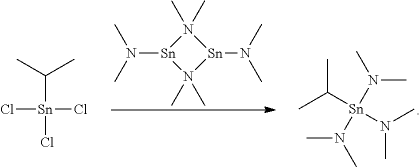

In some embodiments, the method of synthesis comprises reacting [ⁱPrSn(O₂CMe)₃] and [[Sn(NMe₂)₂]₂] to form [ⁱPrSn(NMe₂)₃].

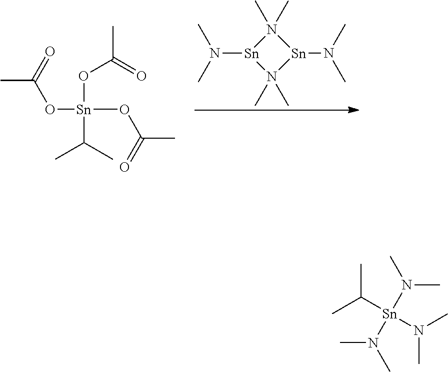

In some embodiments, the method of synthesis comprises reacting ⁱPrSn(O₂CMe)₃ and LiNMe₂ to form ⁱPrSn(NMe₂)₃.

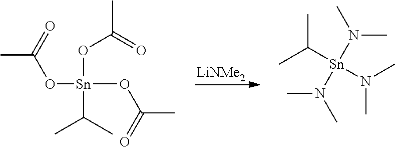 [SMILES: CC(=O)[O][Sn]([O]C(C)=O)([O]C(C)=O)[CH](C)C ; C[CH](C)[Sn]([N](C)C)([N](C)C)[N](C)C ; "LiNMe2"]

In some embodiments, the method of synthesis proceeds according to the following reaction scheme:

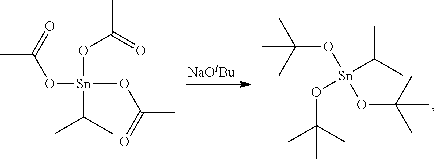 [SMILES: CC(=O)[O][Sn]([O]C(C)=O)([O]C(C)=O)[CH](C)C ; C[CH](C)[Sn]([O]C(C)(C)C)([O]C(C)(C)C)[O]C(C)(C)C ; "NaOtBu"]

In some embodiments, the method of synthesis proceeds according to the following reaction scheme:

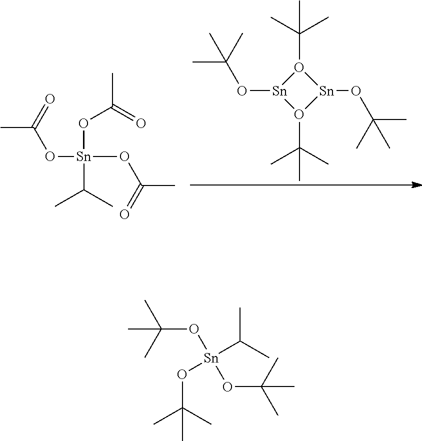

In some embodiments, the method of synthesis comprises reacting iPrSn(benzoate)₃ and [Sn(NMe₂)₂]₂ to form iPrSn(NMe₂)₃.

In some embodiments, the method of synthesis comprises reacting iPropenylSnCl₃ and [Sn(NMe₂)₂]₂ to form iPropenylSn(NMe₂)₃.

In some embodiments, the method of synthesis comprises:

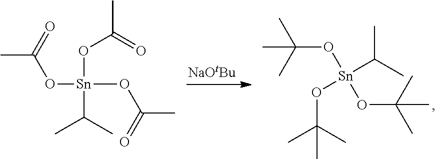 [SMILES: CC(=O)[O][Sn]([O]C(C)=O)([O]C(C)=O)[CH](C)C ; C[CH](C)[Sn]([O]C(C)(C)C)([O]C(C)(C)C)[O]C(C)(C)C ; "NaOtBu"]

In some embodiments, the method of synthesis proceeds according to the following reaction scheme:

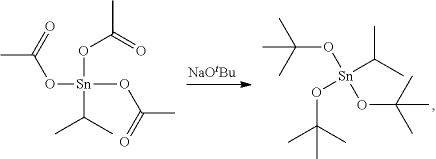 [SMILES: CC(=O)[O][Sn]([O]C(C)=O)([O]C(C)=O)[CH](C)C ; C[CH](C)[Sn]([O]C(C)(C)C)([O]C(C)(C)C)[O]C(C)(C)C ; "NaOtBu"]

In some embodiments, the method of synthesis comprises reacting ⁱPrSn(O₂CMe)₃ and LiNMe₂ to form ⁱPrSn(NMe₂)₃.

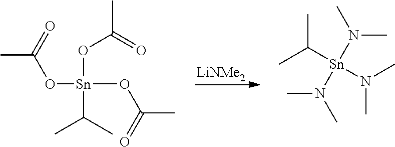 [SMILES: CC(=O)[O][Sn]([O]C(C)=O)([O]C(C)=O)[CH](C)C ; C[CH](C)[Sn]([N](C)C)([N](C)C)[N](C)C ; "LiNMe2"]

In some embodiments, the method of synthesis comprises reacting iPrSnCl₃ and [Sn(NMe₂)₂]₂ to form ⁱPrSn(NMe₂)₃.

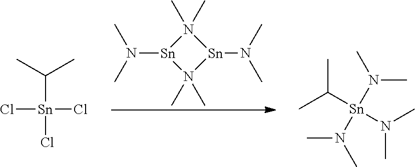

In some embodiments, the method of synthesis comprises reacting ⁱPrSn(O₂CMe)₃ and [Sn(NMe₂)₂]₂ to form ⁱPrSn(NMe₂)₃.

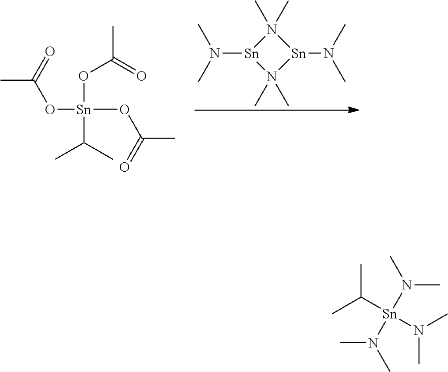

In some embodiments, the method of synthesis comprises reacting iPrSn(benzoate)₃ and [Sn(NMe₂)₂]₂ to form iPrSn(NMe₂)₃.

In some embodiments, the method of synthesis comprises reacting iPropenyISnCl₃ and [Sn(NMe₂)₂]₂ to form iPropenylSn(NMe₂)₃.

### Example 1

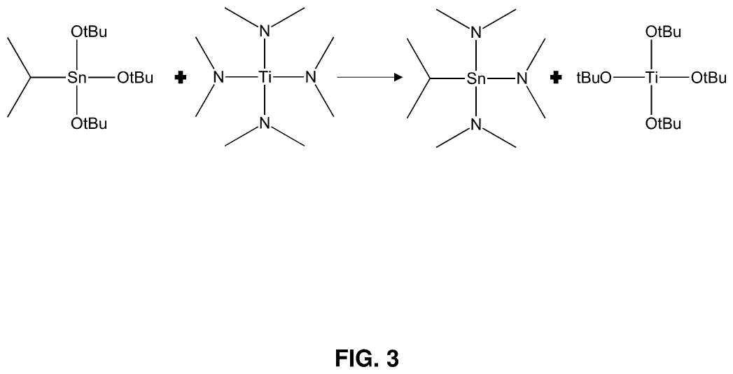

FIG. 3 depicts a reaction scheme of a method of synthesis for a tin (IV) amide compound which is substituted with an isopropyl group, according to some embodiments. To synthesize the tin (IV) amide compound, 20 g (52.4 mmol) of iPrSn(OtBu)₃ was loaded into a 40 mL amber vial fitted with a stir bar. To this, Ti(NMe₂)₄ (8.8 g, 39.3 mmol) was added dropwise slowly to control the exotherm. The reaction mixture was allowed to stir overnight. iPrSn(NMe₂)₃: ¹H-NMR (400 MHz, C₆D₆, 298K): 1.46 (d, 6H); 1.89 (m, 1H); 2.83 (s, 18H); ¹¹⁹Sn {¹H}-NMR (149 MHZ, C₆D₆, 298K): −64.9 ppm.

### Example 2

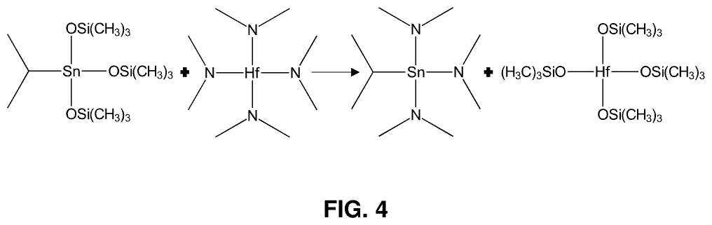

FIG. 4 depicts a reaction scheme of a method of synthesis for a tin (IV) amide compound which is substituted with an isopropyl group, according to some embodiments. iPrSn(OTMS)₃ (1.22 g, 2.86 mmol) was placed in an amber vial and dissolved in C₆D₆ (0.500 g). Separately, Hf(NMe₂)₄ (0.54 g, 2.86 mmol) was dissolved in C₆D₆ (0.500 g) and the colorless solution added to the iPrSn(OTMS)₃ solution. The reaction rapidly presented with an exotherm; remaining a colorless solution. iPrSn(NMe₂)₃: ¹¹⁹Sn {¹H}-NMR (149 MHZ, C₆D₆, 298K): −64.3 ppm.

### Example 3

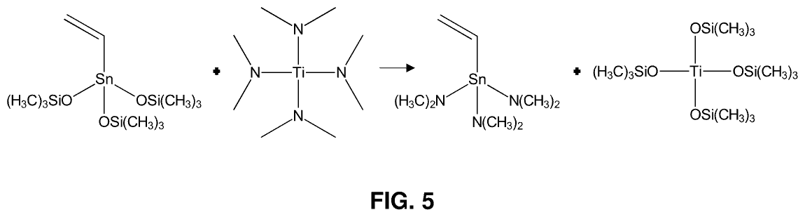

FIG. 5 depicts a reaction scheme of a method of synthesis for a tin (IV) amide compound which is substituted with a vinyl group, according to some embodiments. To synthesize the tin (IV) amide compound, In a 40 mL amber vial, ViSn(OTMS)₃ (1 g, 2.41 mmol) was dissolved in 1 g of C₆D₆. Ti(NMe₂)₄ (270 mg, 1.21 mmol) was added. A slight warming was felt. The solution was the palest yellow in color. ViSn(NMe₂)₃: ¹H-NMR (400 MHZ, C₆D₆, 298K): 2.73 (s, 18H); 5.61 to 6.43 (m, 3H) 119Sn {¹H}-NMR (149 MHZ, C₆D₆, 298K): −92.0 ppm.

### Example 4

### Synthesis of iPrSn(NMe₂)₃ from iPrSn(benzoate)₃ and [Sn(NMe₂)₂]₂

In a 40 mL amber vial, in the glovebox, [Sn(NMe₂)₂]₂ (1.31 g, 6.34 mmol) and iPrSn(benzoate)₃ (1.11 g, 2.11 mmol) were combined. Two mL of C₆D₆ was added and the vial shaken. After about 1 minute, the mixture became opaque. After 20 min the material was filtered through a 0.2 um syringe filter. The collected liquid was bright yellow in color. NMR recorded on a neat solution of the product was consistent with formation of iPrSn(NMe₂)₃ (−64 ppm) with no dialkyl (iPr₂Sn(NMe₂)₂) present as determined by ¹¹⁹Sn-NMR.

### Example 5

### Synthesis of iPropenylSn(NMe₂)₃ from iPropenylSnCl₃ and [Sn(NMe₂)₂]₂

In a 100 mL Schlenk flask, dimethylamine (1.78 g, 19.7 mL, 2.0 molar, 39.5 mmol) was added, followed by quick addition of isopropenylSnCl₃ (5.00 g, 18.8 mmol). The mixture was allowed to stir overnight.

The volatiles were then removed by vacuum and the solids were dried. The solids were then suspended in 50 mL of hexanes, and then [Sn(NMe₂)₂]₂ (11.7 g, 56.4 mmol) was added quickly. The mixture was allowed to stir overnight.

The following morning the flask was placed in the −35° C. freezer for 20 min. The reaction mixture was then filtered through a disposable polypropylene frit. Solids washed with additional cold hexanes. Volatiles were removed under vacuum. Collected 5.2 g of a cloudy yellow liquid. Sample made for NMR analysis.

¹¹⁹Sn-NMR confirmed the material was isopropenylSn(NMe₂)₃ (−99 ppm), with less than 0.1% of dialkyl (isopropenyl₂Sn(NMe₂)₂, −87 ppm) present.

### Example 6

### Synthesis of iPrSn(NMe₂)₃ from iPrSnCl₃ and [Sn(NMe₂)₂]₂

ⁱPrSnCl₃ (1.00 g, 3.73 mmol) was loaded into a 40 mL amber vial equipped with a magnetic stir bar and diluted with hexanes (10 mL). [Sn(NMe₂)₂]₂ (2.31 g, 5.59 mmol) was dissolved in hexanes (25 mL) to form a flaxen solution which was added to the ⁱPrSnCl₃-containing vial with stirring over the course of 2 minutes, resulting in formation of a flocculent precipitate. Upon complete addition, the resulting mixture was stirred for 72 hours. The mixture was allowed to settle, the mother liquor was filtered through a 0.2 μm syringe filter, and the resulting pale green/yellow solution was dried under reduced pressure to yield 0.54 g of a nearly colorless liquid. NMR recorded on a C₆De solution of the product is consistent with formation of ⁱPrSn(NMe₂)₃ with no dialkyl (ⁱPr₂Sn(NMe₂)₂) present by ¹¹⁹Sn-NMR.

### Example 7

### Synthesis of PrSn(NMe₂)₃ from [PrSn(O₂CMe) s and [Sn(NMe₂)_{2]}₂

ⁱPrSn(O₂CMe)₃ (1.0 g, 2.95 mmol) and Sn(NMe₂)₂]₂ (1.83 g, 4.43 mmol) were combined in a 40 mL amber vial equipped with a magnetic stir bar and diluted with 30 mL of hexanes. The resulting mixture was stirred at 60° C. for 12 hours, whereby, the reaction presented as a thick canary-yellow mixture after several seconds. The yellow mixture was cooled to room temperature, the mother liquor was decanted and filtered through a 0.2 μm syringe filter, and the resulting pale-yellow solution was dried under reduced pressure to yield a light-yellow liquid. NMR collected on a C₆D₆ solution. The target molecule (iPrSn(NMe₂)₃) was formed as determined by ¹¹⁹Sn-NMR.

### Example 8

### Synthesis of PrSn(NMe₂)₃ from iPrSn(O₂CMe)₃ and LiNMe₂

ⁱPrSn(O₂CMe)₃ (0.250 g, 0.738 mmol) was loaded into a 40 mL vial equipped with a magnetic stir bar and diluted with C₆D₆ (0.5 mL) to form a yellow solution. LiNMe₂ (0.119 g, 2.32 mmol) was added directly to the yellow solution with stirring, resulting in the formation of a thick white mixture which was stirred at room temperature for 72 hours. The reaction mixture was allowed to settle, an aliquot was collected and filtered through a 0.2 μm syringe filter, and the resulting colorless solution was submitted for analysis by NMR. The starting material (iPrSn(O₂CMe)₃) was no longer present and the target molecules (iPrSn(NMe₂)₃) was observed as determined by ¹¹⁹Sn-NMR (−64 ppm).

### Aspects

Various Aspects are described below. It is to be understood that any one or more of the features recited in the following Aspect(s) can be combined with any one or more other Aspect(s).
Aspect 1. A method of synthesis comprising:
   contacting a tin (IV) alkoxide compound with a metal amide compound to form at least one reaction product,
      wherein the tin (IV) alkoxide compound comprises a compound of the formula:

RₙSn(OR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3;
wherein the metal amide compound comprises a compound of the formula:

M(NR″₂)ₐX_{b},
where:
M is an alkali metal cation, an alkaline earth metal cation, a transition metal cation, or a post-transition metal cation;
R″ is independently a hydrogen, an alkyl, a cycloalkyl, an aryl, or a silyl, or are bonded to each other to form a C₃-C₂₀ N-heterocycle;
X is independently a cyclopentadienyl, an indenyl, a chloro, a bromo, an iodo, or a fluoro; and

a+b=2 to 5.
Aspect 2. The method according to Aspect 1, wherein at least 0.25 equivalents of the metal amide compound are contacted with the tin (IV) alkoxide compound.
Aspect 3. The method according to any one of Aspects 1-2, wherein 0.5 to 2 equivalents of the metal amide compound are contacted with the tin (IV) alkoxide compound.
Aspect 4. The method according to any one of Aspects 1-3, wherein the tin (IV) alkoxide compound comprises a compound of the formula:

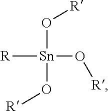

where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof; and
   OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.
Aspect 5. The method according to Aspect 4, wherein R comprises at least one of an unsaturated alkyl, a saturated alkyl, a linear alkyl, a branched alkyl, a fluoroalkyl, a halogen, an oxygen, a nitrogen, a silicon, or any combination thereof.
Aspect 6. The method according to Aspect 4, wherein R is at least one of —CH₂CF₃, —CH(CF₃)₂, —CH₂F, —CH₂CH₂F, —CF₃, —CF₂CF₃, or any combination thereof.
Aspect 7. The method according to Aspect 4, wherein R is isopropyl.
Aspect 8. The method according to Aspect 4, wherein R is vinyl.
Aspect 9. The method according to Aspect 4, wherein OR′ comprises tert-butyl.
Aspect 10. The method according to Aspect 4, wherein OR′ comprises trimethylsilyl.
Aspect 11. The method according to any one of Aspects 1-10, wherein the tin (IV) alkoxide compound is at least one of the following compounds:

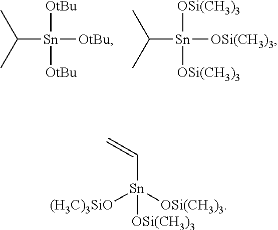

Aspect 12. The method according to any one of Aspects 1-11, wherein the metal amide compound is a compound of the formula:

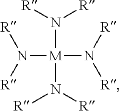

where:
   M is Ti, Zr, or Hf; and
   R″ is independently a hydrogen, an alkyl, a cycloalkyl, an aryl, or a silyl, or are bonded to each other to form a C₃-C₂₀ N-heterocycle.
Aspect 13. The method according to Aspect 12, wherein M is Ti, Zr, or Hf.
Aspect 14. The method according to Aspect 12, wherein R″ is a methyl.
Aspect 15. The method according to any one of Aspects 1-14, wherein the metal amide compound is at least one of the following compounds:

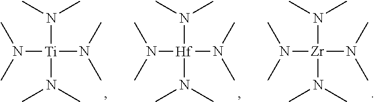

Aspect 16. The method according to any one of Aspects 1-15, wherein the at least one reaction product comprises a tin (IV) amide compound of the formula:

RₙSn(NR″₂)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R″ is independently a hydrogen, an alkyl, a cycloalkyl, an aryl, or a silyl, or are bonded to each other to form a C₃-C₂₀ N-heterocycle; and
   n is 0 to 3.
Aspect 17. The method according to any one of Aspects 1-16, wherein the at least one reaction product comprises a tin (IV) amide compound of the formula:

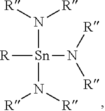

where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof; and
   R″ is independently a hydrogen, an alkyl, a cycloalkyl, an aryl, or a silyl, or are bonded to each other to form a C₃-C₂₀ N-heterocycle.
Aspect 18. The method according to Aspect 17, wherein R comprises at least one of an unsaturated alkyl, a saturated alkyl, a linear alkyl, a branched alkyl, a fluoroalkyl, a halogen, an oxygen, a nitrogen, a silicon, or any combination thereof.
Aspect 19. The method according to Aspect 17, wherein R is at least one of —CH₂CF₃, —CH(CF₃)₂, —CH₂F, —CH₂CH₂F, —CF₃, —CF₂CF₃, or any combination thereof.
Aspect 20. The method according to Aspect 17, wherein R is isopropyl.
Aspect 21. The method according to Aspect 17, wherein R is vinyl.
Aspect 22. The method according to Aspect 17, wherein R″ is a methyl.
Aspect 23. The method according to any one of Aspects 1-22, wherein the at least one reaction product comprises a tin (IV) amide compound of at least one of the following formulas:

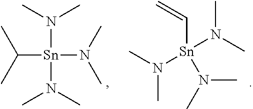

Aspect 24. The method according to any one of Aspects 1-23, wherein the at least one reaction product comprises a metal alkoxide compound of the formula:

M(OR′)_{q},
where:
   M is an alkali metal cation, an alkaline earth metal cation, a transition metal cation, or a post-transition metal cation;
   OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and q is 2 to 5.
Aspect 25. The method according to any one of Aspects 1-24, wherein the at least one reaction product comprises a metal alkoxide compound of the formula:

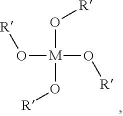

where:
   M is a transition metal cation or a post-transition metal cation; and
   OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.
Aspect 26. The method according to Aspect 25, wherein M is Ti, Zr, or Hf.
Aspect 27. The method according to Aspect 25, wherein OR′ comprises tert-butyl.
Aspect 28. The method according to Aspect 25, wherein OR′ comprises trimethylsilyl.
Aspect 29. The method according to any one of Aspects 1-28, wherein the at least one reaction product comprises a metal alkoxide compound of at least one of the following formulas:

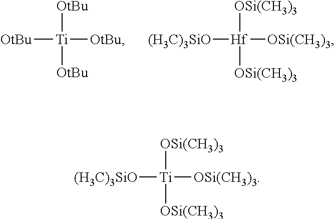

Aspect 30. A composition comprising:
   a tin (IV) amide compound of the formula:

RₙSn(NR″₂)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R″ is independently a hydrogen, an alkyl, a cycloalkyl, an aryl, or a silyl, or are bonded to each other to form a C₃-C₂₀ N-heterocycle; and
   n is 0 to 3.
Aspect 31. The composition according to Aspect 30, wherein the tin (IV) amide compound is a compound of the formula:

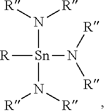

where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof; and
   R″ is independently a hydrogen, an alkyl, a cycloalkyl, an aryl, or a silyl, or are bonded to each other to form a C₃-C₂₀ N-heterocycle.
Aspect 32. The composition according to Aspect 31, wherein R comprises at least one of an unsaturated alkyl, a saturated alkyl, a linear alkyl, a branched alkyl, a fluoroalkyl, a halogen, an oxygen, a nitrogen, a silicon, or any combination thereof.
Aspect 33. The composition according to Aspect 31, wherein R is at least one of —CH₂CF₃, —CH(CF₃)₂, —CH₂F, —CH₂CH₂F, —CF₃, —CF₂CF₃, or any combination thereof.
Aspect 34. The composition according to Aspect 31, wherein R is isopropyl. Aspect 35. The composition according to Aspect 31, wherein R is vinyl.
Aspect 36. The composition according to Aspect 31, wherein R″ is a methyl.
Aspect 37. The composition according to any one of Aspects 30-36, wherein the tin (IV) amide compound comprises at least one of the following formulas:

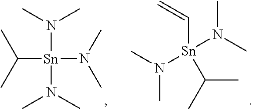

Aspect 38. The composition according to any one of Aspects 30-37, wherein a purity of the tin (IV) amide compound is at least 99%.
Aspect 39. A composition comprising:
   a metal alkoxide compound of the formula:

M(OR′)_{q},
where:
   M is an alkali metal cation, an alkaline earth metal cation, a transition metal cation, or a post-transition metal cation;
   OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.
Aspect 40. The composition according to Aspect 39, wherein the metal alkoxide compound is a compound of the formula:

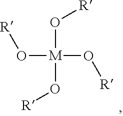

where:
   M is a transition metal cation or a post-transition metal cation; and
   OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.
Aspect 41. The composition according to Aspect 40, wherein M is Ti, Zr, or Hf.
Aspect 42. The composition according to Aspect 40, wherein OR′ comprises tert-butyl.
Aspect 43. The composition according to Aspect 40, wherein OR′ comprises trimethylsilyl.
Aspect 44. The composition according to any one of Aspects 39-43, wherein the metal alkoxide compound comprises at least one of the following formulas:

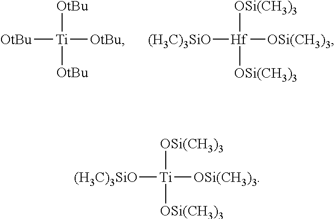

Aspect 45. The composition according to any one of Aspects 39-44, wherein a purity of the metal alkoxide compound is at least 99%.
Aspect 46. A method comprising:
   contacting a tin (IV) compound with a reagent to form at least one reaction product,
      wherein the tin (IV) compound comprises a compound of the formula:

RₙSn(Q)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3;
   wherein the reagent comprises at least one of a metal alkoxide compound, a metal amide compound, or any combination thereof.
Aspect 47. The method according to Aspect 46, wherein the tin (IV) compound comprises a tin (IV) alkoxide compound of the formula:

RₙSn(OR′)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3.
Aspect 48. The method according to any one of Aspects 46-47, wherein the tin (IV) compound comprises a tin (IV) carboxylate compound of the formula:

RₙSn(O₂CR′)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R′ is independently at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3.
Aspect 49. The method according to Aspect 48, wherein R is a C₁-C₆ alkyl.
Aspect 50. The method according to Aspect 49, wherein R′ is independently a hydrogen, a C₁-C₆ alkyl, or a phenyl.
Aspect 51. The method according to Aspect 49, wherein R′ is independently —H, —CH₃, —CH₂CH₃, —CH₂CH₂CH₃, or -(phenyl).
Aspect 52. The method according to any one of Aspects 46-51, wherein the tin (IV) compound comprises a tin (IV) carboxylate compound of the formula:

RₙSn(O₂CR′)₄₋ₙ,
where:
   R is an isopropyl;
   R′ is a methyl; and
   n is 1.
Aspect 53. The method according to any one of Aspects 46-52, wherein the tin (IV) compound comprises a tin (IV) carboxylate compound of the formula:

RₙSn(O₂CR′)₄₋ₙ,
where:
   R is an isopropyl;
   R′ is a phenyl; and
   n is 1.
Aspect 54. The method according to any one of Aspects 46-53, wherein the tin (IV) compound comprises a tin (IV) halide compound of the formula:

RₙSn(halide)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   halide is Cl, Br, or I; and
   n is 0 to 3.
Aspect 55. The method according to Aspect 54, wherein R is a C₁-C₆ alkyl.
Aspect 56. The method according to any one of Aspects 46-55, wherein the tin (IV) compound comprises a tin (IV) halide compound of the formula:

RₙSn(halide)₄₋ₙ,
where:
   R is an isopropyl;
   halide is Cl, Br, or I; and
   n is 1.
Aspect 57. The method according to any one of Aspects 46-56, wherein the tin (IV) compound comprises a tin (IV) halide compound of the formula:

RₙSn(halide)₄₋ₙ,
where:
   R is an isopropenyl;
   halide is Cl, Br, or I; and
   n is 1.
Aspect 58. The method according to any one of Aspects 46-57, wherein the metal amide compound comprises a compound of the formula:

M(NR″₂)ₐX_{b},
where:
   M is an alkali metal cation, an alkaline earth metal cation, a transition metal cation, or a post-transition metal cation;
   R″ is independently a hydrogen, an alkyl, a cycloalkyl, an aryl, or a silyl, or are bonded to each other to form a C₃-C₂₀ N-heterocycle;
   X is independently a cyclopentadienyl, an indenyl, a chloro, a bromo, an iodo, or a fluoro; and

a+b=2 to 5.
Aspect 59. The method according to any one of Aspects 46-58, wherein the metal amide compound comprises a compound of the formula:

M(NR″₂),
where:
   M is a lithium, a sodium, or a magnesium;
   R″ is independently a C₁-C₆ alkyl.
Aspect 60. The method according to any one of Aspects 46-59, wherein the metal amide compound comprises a compound of the formula:

M(NR″₂),
where:
   M is a lithium (Li);
   R″ is a methyl.
Aspect 61. The method according to any one of Aspects 46-60, wherein the metal amide compound comprises a compound of the formula:

[M(NR″₂)₂]ₙ,
where:
   M is an alkali metal cation, an alkaline earth metal cation, a transition metal cation, or a post-transition metal cation;
   R″ is independently a hydrogen, an alkyl, a cycloalkyl, an aryl, or a silyl, or are bonded to each other to form a C₃-C₂₀ N-heterocycle; and
   n is 1 or 2.
Aspect 62. The method according to any one of Aspects 46-61, wherein the metal amide compound comprises a compound of the formula:

[Sn(NR″₂)₂]ₙ,
where:
   R″ is independently a hydrogen, an alkyl, a cycloalkyl, an aryl, or a silyl, or are bonded to each other to form a C₃-C₂₀ N-heterocycle; and
   n is 1 or 2.
Aspect 63. The method according to any one of Aspects 46-62, wherein the metal amide compound comprises a compound of the formula:

[Sn(NR″₂)₂]ₙ,
where:
   R″ is a C₁-C₆ alkyl; and
   n is 2.
Aspect 64. The method according to any one of Aspects 46-63, wherein the metal amide compound comprises a compound of the formula:

[Sn(NR″₂)₂]ₙ,
where:
   R″ is a methyl; and
   n is 2.
Aspect 65. The method according to any one of Aspects 46−64, wherein the metal alkoxide compound comprises a compound of the formula:

M(OR″)ₙ,
where:
   M is an alkali metal cation, an alkaline earth metal cation, a transition metal cation, or a post-transition metal cation;
   R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
   n is 1 to 5.
Aspect 66. The method according to any one of Aspects 46-65, wherein the metal alkoxide compound comprises a compound of the formula:

M(OR″)ₙ,
where:
   M is an alkali metal cation or an alkaline earth metal cation;
   R″ is independently a C₁-C₆ alkyl; and
   n is 1 or 2.
Aspect 67. The method according to any one of Aspects 46-66, wherein the metal alkoxide compound comprises a compound of the formula:

M(OR″)ₙ,
where:
   M is a sodium, a lithium, or a magnesium;
   R″ is independently a C₁-C₆ alkyl; and
   n is 1 or 2.
Aspect 68. The method according to any one of Aspects 46-67, wherein the metal alkoxide compound comprises a compound of the formula:

M(OR″)ₙ,
where:
   M is a sodium (Na);
   R″ is a tert-butyl; and
   n is 1.
Aspect 69. The method according to any one of Aspects 46-68, wherein the metal alkoxide compound comprises a compound of the formula:

[M(OR″)₂]ₙ,
where:
   M is an alkali metal cation, an alkaline earth metal cation, a transition metal cation, or a post-transition metal cation;
   R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
   n is 1 or 2.
Aspect 70. The method according to any one of Aspects 46-69, wherein the metal alkoxide compound comprises a compound of the formula:

[Sn(OR″)₂]ₙ,
where:
   R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
   n is 1 or 2.
71. The method according to any one of Aspects 46-70, wherein the metal alkoxide compound comprises a compound of the formula:

[Sn(OR″)₂]ₙ,
where:
   R″ is a tert-butyl; and
   n is 2.
Aspect 72. The method according to any one of Aspects 46-71, wherein the at least one reaction product comprises a tin (IV) amide compound of the formula:

RₙSn(NR″₂)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R″ is independently a hydrogen, an alkyl, a cycloalkyl, an aryl, or a silyl, or are bonded to each other to form a C₃-C₂₀ N-heterocycle; and
   n is 0 to 3.
Aspect 73. The method according to any one of Aspects 46-72, wherein the at least one reaction product comprises a tin (IV) amide compound of the formula:

RₙSn(NR″₂)₄₋ₙ,
where:
   R is a C₁-C₆ alkyl;
   R″ is a C₁-C₆ alkyl; and
   n is 1.
Aspect 74. The method according to any one of Aspects 46-73, wherein the at least one reaction product comprises a tin (IV) amide compound of the formula:

RₙSn(NR″₂)₄₋ₙ,
where:
   R is an isopropyl;
   R″ is a methyl; and
   n is 1.
Aspect 75. The method according to any one of Aspects 46-74, wherein the at least one reaction product comprises a tin (IV) amide compound of the formula:

RₙSn(NR″₂)₄₋ₙ,
where:
   R is an isopropenyl;
   R″ is a methyl; and
   n is 1.
Aspect 76. The method according to any one of Aspects 46-75, wherein the tin (IV) compound comprises a tin (IV) halide compound of the formula:

RₙSn(halide)₄₋ₙ,
where:
   R is an isopropyl;
   halide is Cl, Br, or I; and
   n is 1;
wherein the metal amide compound comprises a compound of the formula:

[Sn(NR″₂)₂]ₙ,
where:
   R″ is a methyl; and
   n is 2;
wherein the at least one reaction product comprises a tin (IV) amide compound of the formula:

RₙSn(NR″₂)₄₋ₙ,
where:
   R is an isopropyl;
   R″ is a methyl; and
   n is 1.
Aspect 77. The method according to any one of Aspects 46-76, wherein the tin (IV) compound comprises a tin (IV) carboxylate compound of the formula:

RₙSn(O₂CR′)₄₋ₙ,
where:
   R is an isopropyl;
   R′ is a methyl; and
   n is 1;
wherein the metal amide compound comprises a compound of the formula:

[Sn(NR″₂)₂]ₙ,
where:
   R″ is a methyl; and
   n is 2;
wherein the at least one reaction product comprises a tin (IV) amide compound of the formula:

RₙSn(NR″₂)₄₋ₙ,
where:
   R is an isopropyl;
   R″ is a methyl; and
   n is 1.
Aspect 78. The method according to any one of Aspects 46-77,
   wherein the tin (IV) compound comprises a tin (IV) carboxylate compound of the formula:

RₙSn(O₂CR′)₄₋ₙ,
where:
   R is an isopropyl;
   R′ is a methyl; and
   n is 1;
wherein the metal amide compound comprises a compound of the formula:

M(NR″₂),
where:
   M is a lithium (Li);
   R″ is a methyl;
wherein the at least one reaction product comprises a tin (IV) amide compound of the formula:

RₙSn(NR″₂)₄₋ₙ,
where:
   R is an isopropyl;
   R″ is a methyl; and
   n is 1.
Aspect 79. The method according to any one of Aspects 46-78,
   wherein the tin (IV) compound comprises a tin (IV) carboxylate compound of the formula:

RₙSn(O₂CR′)₄₋ₙ,
where:
   R is an isopropyl;
   R′ is a methyl; and
   n is 1;
wherein the metal alkoxide compound comprises a compound of the formula:

M(OR″)ₙ,
where:
   M is a sodium (Na);
   R″ is a tert-butyl; and
   n is 1;
wherein the at least one reaction product comprises a tin (IV) alkoxide compound of the formula:

RₙSn(OR″)₄₋ₙ,
where:
   R is an isopropyl;
   R″ is a tert-butyl; and
   n is 1.
Aspect 80. The method according to any one of Aspects 46-79, wherein the tin (IV) compound comprises a tin (IV) carboxylate compound of the formula:

RₙSn(O₂CR′)₄₋ₙ,
where:
   R is an isopropyl;
   R′ is a methyl; and
   n is 1;
wherein the metal alkoxide compound comprises a compound of the formula:

[Sn(OR″)₂]ₙ,
where:
   R″ is a tert-butyl; and
   n is 2;
wherein the at least one reaction product comprises a tin (IV) alkoxide compound of the formula:

RₙSn(OR″)₄₋ₙ,
where:
   R is an isopropyl;
   R″ is a tert-butyl; and
   n is 1.
Aspect 81. The method according to any one of Aspects 46-80, wherein the tin (IV) compound comprises a tin IV carboxylate compound of the formula:

RₙSn(O₂CR′)₄₋ₙ,
where:
   R is an isopropyl;
   R′ is a phenyl; and
   n is 1;
wherein the metal amide compound comprises a compound of the formula:

[Sn(NR″₂)₂]ₙ,
where:
   R″ is a methyl; and
   n is 2;
wherein the at least one reaction product comprises a tin (IV) amide compound of the formula:

RₙSn(NR″₂)₄₋ₙ,
where:
   R is an isopropyl;
   R″ is a methyl; and
   n is 1.
Aspect 82. The method according to any one of Aspects 46-81, wherein the tin (IV) compound comprises a tin IV halide compound of the formula:

RₙSn(halide)₄₋ₙ,
where:
   R is an isopropenyl;
   halide is Cl, Br, or I; and
   n is 1;
wherein the metal amide compound comprises a compound of the formula:

[Sn(NR″₂)₂]ₙ,
where:
   R″ is a methyl; and
   n is 2;
wherein the at least one reaction product comprises a tin (IV) amide compound of the formula:

RₙSn(NR″₂)₄₋ₙ,
where:
   R is an isopropenyl;
   R″ is a methyl; and
   n is 1.
Aspect 83. The method according to any one of Aspects 46-82, wherein the at least one reaction product comprises a tin (IV) alkoxide compound of the formula:

RₙSn(OR″)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
   n is 0 to 3.
Aspect 84. The method according to any one of Aspects 46-83, wherein the at least one reaction product comprises a tin (IV) alkoxide compound of the formula:

RₙSn(OR″)₄₋ₙ,
where:
   R is a C₁-C₆ alkyl;
   R″ is a C₁-C₆ alkyl; and
   n is 1.
Aspect 85. The method according to any one of Aspects 46-84, wherein the at least one reaction product comprises a tin (IV) alkoxide compound of the formula:

RₙSn(OR″)₄₋ₙ,
where:
   R is an isopropyl;
   R″ is a tert-butyl; and
   n is 1.

(RSnX₃+M(OR)ₙ→RSn(OR)₃)
Aspect 86. A method comprising:
   contacting a tin (IV) compound with a metal alkoxide compound to form at least one reaction product,
      wherein the tin (IV) compound comprises a compound of the formula:

RₙSn(Q)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3;
wherein the metal alkoxide compound comprises a compound of the formula:

M(OR″)ₙ,
where:
   M is an alkali metal cation, an alkaline earth metal cation, a transition metal cation, or a post-transition metal cation;
   R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
   n is 1 to 5.

Aspect 87. The method according to Aspect 86, wherein the tin (IV) compound comprises a tin (IV) alkoxide compound of the formula:

RₙSn(OR′)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3.
Aspect 88. The method according to any one of Aspects 86-87, wherein the tin (IV) compound comprises a tin (IV) carboxylate compound of the formula:

RₙSn(O₂CR′)₄₋₁,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R′ is independently at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3.
Aspect 89. The method according to any one of Aspects 86-88, wherein R is a C₁-C₆ alkyl.
Aspect 90. The method according to any one of Aspects 86-89, wherein R′ is independently a hydrogen, a C₁-C₆ alkyl, or a phenyl.
Aspect 91. The method according to any one of Aspects 86-90, wherein R′ is independently —H, —CH₃, —CH₂CH₃, —CH₂CH₂CH₃, or -(phenyl).
Aspect 92. The method according to any one of Aspects 86-91, wherein the tin (IV) compound comprises a tin (IV) halide compound of the formula:

RₙSn(halide)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   halide is Cl, Br, or I; and
   n is 0 to 3.
Aspect 93. The method according to any one of Aspects 86-92, wherein R is a C₁-C₆ alkyl.
Aspect 94. The method according to any one of Aspects 86-93, wherein the metal alkoxide compound comprises a compound of the formula:

M(OR″)ₙ,
where:
   M is an alkali metal cation or an alkaline earth metal cation;
   R″ is independently a C₁-C₆ alkyl; and
   n is 1 or 2.
Aspect 95. The method according to any one of Aspects 86-94, wherein the metal alkoxide compound comprises a compound of the formula:

M(OR″)ₙ,
where:
   M is a sodium, a lithium, or a magnesium;
   R″ is independently a C₁-C₆ alkyl; and
   n is 1 or 2.
Aspect 96. The method according to any one of Aspects 86-95, wherein the metal alkoxide compound comprises a compound of the formula:

M(OR″)ₙ,
where:
   M is a sodium (Na);
   R″ is a tert-butyl; and
   n is 1.
Aspect 97. The method according to any one of Aspects 86-96, wherein the at least one reaction product comprises a tin (IV) alkoxide compound of the formula:

RₙSn(OR″)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
   n is 0 to 3.
Aspect 98. The method according to any one of Aspects 86-97, wherein the tin (IV) compound comprises a tin (IV) carboxylate compound of the formula:

RₙSn(O₂CR′)₄₋ₙ,
where:
   R is an isopropyl;
   R′ is a methyl; and
   n is 1;
wherein the metal alkoxide compound comprises a compound of the formula:

M(OR″)ₙ,
where:
   M is a sodium (Na);
   R″ is a tert-butyl; and
   n is 1;
wherein the at least one reaction product comprises a tin (IV) alkoxide compound of the formula:

RₙSn(OR″)₄₋ₙ,
where:
   R is an isopropyl;
   R″ is a tert-butyl; and
   n is 1.

(RSnX₃+[Sn(OR)₂]ₙ→RSn(OR)₃)
Aspect 99. A method comprising:
   contacting a tin (IV) compound with a metal alkoxide compound to form at least one reaction product,
      wherein the tin (IV) compound comprises a compound of the formula:

RₙSn(Q)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3;
wherein the metal alkoxide compound comprises a compound of the formula:

[M(OR″)₂]ₙ,
where:
   M is an alkali metal cation, an alkaline earth metal cation, a transition metal cation, or a post-transition metal cation;
   R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
   n is 1 or 2.
Aspect 100. The method according to Aspect 99, wherein the tin (IV) compound comprises a tin (IV) alkoxide compound of the formula:

RₙSn(OR′)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3.
Aspect 101. The method according to any one of Aspects 99-100, wherein the tin (IV) compound comprises a tin (IV) carboxylate compound of the formula:

RₙSn(O₂CR′)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R′ is independently at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3.
Aspect 102. The method according to any one of Aspects 99-101, wherein R is a C₁-C₆ alkyl.
Aspect 103. The method according to any one of Aspects 99-102, wherein R′ is independently a hydrogen, a C₁-C₆ alkyl, or a phenyl.
Aspect 104. The method according to any one of Aspects 99-103, wherein R′ is independently —H, —CH₃, —CH₂CH₃, —CH₂CH₂CH₃, or -(phenyl).
Aspect 105. The method according to any one of Aspects 99-104, wherein the tin (IV) compound comprises a tin (IV) halide compound of the formula:

RₙSn(halide)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   halide is Cl, Br, or I; and
   n is 0 to 3.
Aspect 106. The method according to any one of Aspects 99-105, wherein R is a C₁-C₆ alkyl.
Aspect 107. The method according to any one of Aspects 99-106, wherein the metal alkoxide compound comprises a compound of the formula:

[Sn(OR″)₂]ₙ,
where:
   R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
   n is 1 or 2.
Aspect 108. The method according to any one of Aspects 99-107, wherein the metal alkoxide compound comprises a compound of the formula:

[Sn(OR″)₂]ₙ,
where:
   R″ is a tert-butyl; and
   n is 2.
Aspect 109. The method according to any one of Aspects 99-108, wherein the at least one reaction product comprises a tin (IV) alkoxide compound of the formula:

RₙSn(OR″)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
   n is 0 to 3.
Aspect 110. The method according to any one of Aspects 99-109,
   wherein the tin (IV) compound comprises a tin (IV) carboxylate compound of the formula:

RₙSn(O₂CR′)₄₋ₙ,
where:
   R is an isopropyl;
   R′ is a methyl; and
   n is 1;
wherein the metal alkoxide compound comprises a compound of the formula:

[Sn(OR″)₂]ₙ,
where:
   R″ is a tert-butyl; and
   n is 2;
wherein the at least one reaction product comprises a tin (IV) alkoxide compound of the formula:

RₙSn(OR″)₄₋ₙ,
where:
   R is an isopropyl;
   R″ is a tert-butyl; and
   n is 1.

(RSnX₃+M(NR₂)ₙ→RSn(NR₂)₃)
Aspect 111. A method comprising:
   contacting a tin (IV) compound with a metal amide compound to form at least one reaction product,
      wherein the tin (IV) compound comprises a compound of the formula:

RₙSn(Q)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3;
wherein the metal amide compound comprises a compound of the formula:

M(NR″₂)ₐX_{b},
where:
   M is an alkali metal cation, an alkaline earth metal cation, a transition metal cation, or a post-transition metal cation;
   R″ is independently a hydrogen, an alkyl, a cycloalkyl, an aryl, or a silyl, or are bonded to each other to form a C₃-C₂₀ N-heterocycle;
   X is independently a cyclopentadienyl, an indenyl, a chloro, a bromo, an iodo, or a fluoro; and

a+b=2 to 5.
Aspect 112. The method according to Aspect 111, wherein the tin (IV) compound comprises a tin (IV) alkoxide compound of the formula:

RₙSn(OR′)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3.
Aspect 113. The method according to any one of Aspects 111-112, wherein the tin (IV) compound comprises a tin (IV) carboxylate compound of the formula:

RₙSn(O₂CR′)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R′ is independently at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3.
Aspect 114. The method according to any one of Aspects 111-113, wherein R is a C₁-C₆ alkyl.
Aspect 115. The method according to any one of Aspects 111-114, wherein R′ is independently a hydrogen, a C₁-C₆ alkyl, or a phenyl.
Aspect 116. The method according to any one of Aspects 111-115, wherein R′ is independently —H, —CH₃, —CH₂CH₃, —CH₂CH₂CH₃, or -(phenyl).
Aspect 117. The method according to any one of Aspects 111-117, wherein the tin (IV) compound comprises a tin (IV) halide compound of the formula:

RₙSn(halide)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   halide is Cl, Br, or I; and
   n is 0 to 3.
Aspect 118. The method according to any one of Aspects 111-117, wherein R is a C₁-C₆ alkyl.
Aspect 119. The method according to any one of Aspects 111-118, wherein the metal amide compound comprises a compound of the formula:

M(NR″₂),
where:
   M is an alkali metal cation or an alkaline earth metal cation;
   R″ is independently a C₁-C₆ alkyl.
Aspect 120. The method according to any one of Aspects 111-119, wherein the metal amide compound comprises a compound of the formula:

M(NR″₂),
where:
   M is a lithium, a sodium, or a magnesium;
   R″ is independently a C₁-C₆ alkyl.
Aspect 121. The method according to any one of Aspects 111-120, wherein the metal amide compound comprises a compound of the formula:

M(NR″₂),
where:
   M is a lithium (Li);
   R″ is a methyl.
Aspect 122. The method according to any one of Aspects 111-121, wherein the at least one reaction product comprises a tin (IV) amide compound of the formula:

RₙSn(NR″₂)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R″ is independently a hydrogen, an alkyl, a cycloalkyl, an aryl, or a silyl, or are bonded to each other to form a C₃-C₂₀ N-heterocycle; and
   n is 0 to 3.
Aspect 123. The method according to any one of Aspects 111-122,
   wherein the tin (IV) compound comprises a tin (IV) carboxylate compound of the formula:

RₙSn(O₂CR′)₄₋ₙ,
where:
   R is an isopropyl;
   R′ is a methyl; and
   n is 1;
wherein the metal amide compound comprises a compound of the formula:

M(NR″₂),
where:
   M is a lithium (Li);
   R″ is a methyl;
wherein the at least one reaction product comprises a tin (IV) amide compound of the formula:

RₙSn(NR″₂)₄₋ₙ,
where:
   R is an isopropyl;
   R″ is a methyl; and
   n is 1.

(RSnX₃+[Sn(NR₂)₂]ₙ→RSn(NR₂)₃)
Aspect 124. A method comprising:
   contacting a tin (IV) compound with a reagent to form at least one reaction product,
      wherein the tin (IV) compound comprises a compound of the formula:

RₙSn(Q)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   Q independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3;
wherein the metal amide compound comprises a compound of the formula:

[M(NR″₂)₂]ₙ,
where:
   M is an alkali metal cation, an alkaline earth metal cation, a transition metal cation, or a post-transition metal cation;
   R″ is independently a hydrogen, an alkyl, a cycloalkyl, an aryl, or a silyl, or are bonded to each other to form a C₃-C₂₀ N-heterocycle; and
   n is 1 or 2.
Aspect 125. The method according to Aspect 124, wherein the tin (IV) compound comprises a tin (IV) alkoxide compound of the formula:

RₙSn(OR′)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3.
Aspect 126. The method according to any one of Aspects 124-125, wherein the tin (IV) compound comprises a tin (IV) carboxylate compound of the formula:

RₙSn(O₂CR′)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R′ is independently at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3.
Aspect 127. The method according to any one of Aspects 124-126, wherein R is a C₁-C₆ alkyl.
Aspect 128. The method according to any one of Aspects 124-127, wherein R′ is independently a hydrogen, a C₁-C₆ alkyl, or a phenyl.
Aspect 129. The method according to any one of Aspects 124-128, wherein R′ is independently —H, —CH₃, —CH₂CH₃, —CH₂CH₂CH₃, or -(phenyl).
Aspect 130. The method according to any one of Aspects 124-129, wherein the tin (IV) compound comprises a tin (IV) halide compound of the formula:

RₙSn(halide)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   halide is Cl, Br, or I; and
   n is 0 to 3.
Aspect 131. The method according to any one of Aspects 124-130, wherein R is a C₁-C₆ alkyl.
Aspect 132. The method according to any one of Aspects 124-131, wherein the metal amide compound comprises a compound of the formula:

[Sn(NR″₂)₂]ₙ,
where:
   R″ is independently a hydrogen, an alkyl, a cycloalkyl, an aryl, or a silyl, or are bonded to each other to form a C₃-C₂₀ N-heterocycle; and
   n is 1 or 2.
Aspect 133. The method according to any one of Aspects 124-132, wherein the metal amide compound comprises a compound of the formula:

[Sn(NR″₂)₂]ₙ,
where:
   R″ is a C₁-C₆ alkyl; and
   n is 2.
Aspect 134. The method according to any one of Aspects 124-133, wherein the metal amide compound comprises a compound of the formula:

[Sn(NR″₂)₂]ₙ,
where:
   R″ is a methyl; and
   n is 2.
Aspect 135. The method according to any one of Aspects 124-134, wherein the at least one reaction product comprises a tin (IV) amide compound of the formula:

RₙSn(NR″₂)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R″ is independently a hydrogen, an alkyl, a cycloalkyl, an aryl, or a silyl, or are bonded to each other to form a C₃-C₂₀ N-heterocycle; and
   n is 0 to 3.
Aspect 136. The method according to any one of Aspects 124-135,
   wherein the tin (IV) compound comprises a tin (IV) halide compound of the formula:

RₙSn(halide)₄₋ₙ,
where:
   R is an isopropyl;
   halide is Cl, Br, or I; and
   n is 1;
wherein the metal amide compound comprises a compound of the formula:

[Sn(NR″₂)₂]ₙ,
where:
   R″ is a methyl; and
   n is 2;
wherein the at least one reaction product comprises a tin (IV) amide compound of the formula:

RₙSn(NR″₂)₄₋ₙ,
where:
   R is an isopropyl;
   R″ is a methyl; and
   n is 1.
Aspect 137. The method according to any one of Aspects 124-136,
   wherein the tin (IV) compound comprises a tin (IV) carboxylate compound of the formula:

RₙSn(O₂CR′)₄₋ₙ,
where:
   R is an isopropyl;
   R′ is a methyl; and
   n is 1;
wherein the metal amide compound comprises a compound of the formula:

[Sn(NR″₂)₂]ₙ,
where:
   R″ is a methyl; and
   n is 2;
wherein the at least one reaction product comprises a tin (IV) amide compound of the formula:

RₙSn(NR″₂)₄₋ₙ,
where:
   R is an isopropyl;
   R″ is a methyl; and
   n is 1.
Aspect 138. The method according to any one of Aspects 124-137,
   wherein the tin (IV) compound comprises a tin IV carboxylate compound of the formula:

RₙSn(O₂CR′)₄₋ₙ,
where:
   R is an isopropyl;
   R′ is a phenyl; and
   n is 1;
wherein the metal amide compound comprises a compound of the formula:

[Sn(NR″₂)₂]ₙ,
where:
   R″ is a methyl; and
   n is 2;
wherein the at least one reaction product comprises a tin (IV) amide compound of the formula:

RₙSn(NR″₂)₄₋ₙ,
where:
   R is an isopropyl;
   R″ is a methyl; and
   n is 1.
Aspect 139. The method according to any one of Aspects 124-138,
   wherein the tin (IV) compound comprises a tin IV halide compound of the formula:

RₙSn(halide)₄₋ₙ,
where:
   R is an isopropenyl;
   halide is Cl, Br, or I; and
   n is 1;
wherein the metal amide compound comprises a compound of the formula:

[Sn(NR″₂)₂]ₙ,
where:
   R″ is a methyl; and
   n is 2;
wherein the at least one reaction product comprises a tin (IV) amide compound of the formula:

RₙSn(NR″₂)₄₋ₙ,
where:
   R is an isopropenyl;
   R″ is a methyl; and
   n is 1.
Aspect 140. A composition comprising:
   a tin (IV) carboxylate compound of the formula:

RₙSn(O₂CR′)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R′ is at least one of a hydrogen, an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
   n is 0 to 3.
Aspect 141. The composition according to Aspect 140, wherein R is independently a C₁-C₆ alkyl.
Aspect 142. The composition according to any one of Aspects 140-141, wherein R′ is independently a C₁-C₆ alkyl.
Aspect 143. The composition according to any one of Aspects 140-142, wherein R′ is independently a methyl or a phenyl.
Aspect 144. The composition according to any one of Aspects 140-143, wherein a purity of the tin (IV) carboxylate compound is at least 99%.
Aspect 145. A composition comprising:
   a tin (IV) amide compound of the formula:

RₙSn(NR″₂)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof; R″ is independently a hydrogen, an alkyl, a cycloalkyl, an aryl, or a silyl, or are bonded to each other to form a C₃-C₂₀ N-heterocycle; and
   n is 0 to 3.
Aspect 146. The composition according to Aspect 145, wherein R is independently a C₁-C₆ alkyl.
Aspect 147. The composition according to any one of Aspects 145-146, wherein R″ is independently a C₁-C₆ alkyl.
Aspect 148. The composition according to any one of Aspects 145-147, wherein a purity of the tin (IV) amide compound is at least 99%.
Aspect 149. A composition comprising:
   a tin (IV) alkoxide compound of the formula:

RₙSn(OR″)₄₋ₙ,
where:
   R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
   R″ is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, a cyclopentadienyl, an indenyl, or any combination thereof; and
   n is 0 to 3.
Aspect 150. The composition according to Aspect 149, wherein R is independently a C₁-C₆ alkyl.
Aspect 151. The composition according to any one of Aspects 149-150, wherein R″ is independently a C₁-C₆ alkyl.
Aspect 152. The composition according to any one of Aspects 149-151, wherein a purity of the tin (IV) alkoxide compound is at least 99%.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method of synthesis comprising:
contacting a tin (IV) alkoxide compound with a metal amide compound to form at least one reaction product,
wherein the tin (IV) alkoxide compound comprises a compound of the formula:
RₙSn(OR′)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
n is 0 to 3;
wherein the metal amide compound comprises a compound of the formula:
M(NR″₂)ₐX_{b},
where:
M is an alkali metal cation, an alkaline earth metal cation, a transition metal cation, or a post-transition metal cation;
R″ is independently a hydrogen, an alkyl, a cycloalkyl, an aryl, or a silyl, or are bonded to each other to form a C₃-C₂₀ N-heterocycle;
X is independently a cyclopentadienyl, an indenyl, a chloro, a bromo, an iodo, or a fluoro; and
a+b=2 to 5.

2. The method of claim 1, wherein at least 0.25 equivalents of the metal amide compound are contacted with the tin (IV) alkoxide compound.

3. The method of claim 1, wherein 0.5 to 2 equivalents of the metal amide compound are contacted with the tin (IV) alkoxide compound.

4. The method of claim 1, wherein the tin (IV) alkoxide compound comprises a compound of the formula: 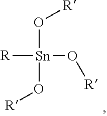
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof; and
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

5. The method of claim 4, wherein R comprises at least one of an unsaturated alkyl, a saturated alkyl, a linear alkyl, a branched alkyl, a fluoroalkyl, a halogen, an oxygen, a nitrogen, a silicon, or any combination thereof.

6. The method of claim 4, wherein R is at least one of —CH₂CF₃, —CH(CF₃)₂, —CH₂F, —CH₂CH₂F, —CF₃, —CF₂CF₃, or any combination thereof.

7. The method of claim 4, wherein R is isopropyl.

8. The method of claim 4, wherein R is vinyl.

9. The method of claim 4, wherein OR′ comprises tert-butyl.

10. The method of claim 4, wherein OR′ comprises trimethylsilyl.

11. The method of claim 1, wherein the tin (IV) alkoxide compound is at least one of the following compounds:

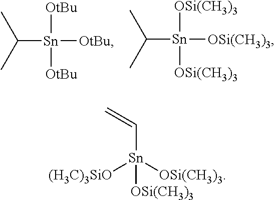

12. The method of claim 1, wherein the metal amide compound is a compound of the formula: 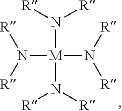
where:
M is Ti, Zr, or Hf; and
R″ is independently a hydrogen, an alkyl, a cycloalkyl, an aryl, or a silyl, or are bonded to each other to form a C₃-C₂₀ N-heterocycle.

13. The method of claim 12, wherein M is Ti, Zr, or Hf.

14. The method of claim 12, wherein R″ is a methyl.

15. The method of claim 1, wherein the metal amide compound is at least one of the following compounds:

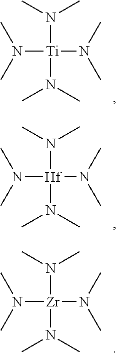

16. The method of claim 1, wherein the at least one reaction product comprises a tin (IV) amide compound of the formula:
RₙSn(NR″₂)₄₋ₙ,
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof;
R″ is independently a hydrogen, an alkyl, a cycloalkyl, an aryl, or a silyl, or are bonded to each other to form a C₃-C₂₀ N-heterocycle; and
n is 0 to 3.

17. The method of claim 1, wherein the at least one reaction product comprises a tin (IV) amide compound of the formula: 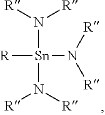
where:
R is at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a cyclopentadienyl, an indenyl, or any combination thereof; and
R″ is independently a hydrogen, an alkyl, a cycloalkyl, an aryl, or a silyl, or are bonded to each other to form a C₃-C₂₀ N-heterocycle.

18. The method of claim 17, wherein R comprises at least one of an unsaturated alkyl, a saturated alkyl, a linear alkyl, a cycloalkyl, a branched alkyl, a fluoroalkyl, a halogen, an oxygen, a nitrogen, a silicon, or any combination thereof.

19. The method of claim 17, wherein R is at least one of —CH₂CF₃, —CH(CF₃)₂, —CH₂F, —CH₂CH₂F, —CF₃, —CF₂CF₃, or any combination thereof.

20. The method of claim 17, wherein R is isopropyl.

21. The method of claim 17, wherein R is vinyl.

22. The method of claim 17, wherein R″ is a methyl.

23. The method of claim 1, wherein the at least one reaction product comprises a tin (IV) amide compound of at least one of the following formulas:

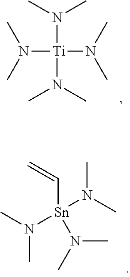

24. The method of claim 1, wherein the at least one reaction product comprises a metal alkoxide compound of the formula:
M(OR′)_{q},
where:
M is an alkali metal cation, an alkaline earth metal cation, a transition metal cation, or a post-transition metal cation;
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof; and
q is 2 to 5.

25. The method of claim 1, wherein the at least one reaction product comprises a metal alkoxide compound of the formula: 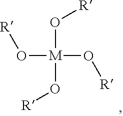
where:
M is a transition metal cation or a post-transition metal cation; and
OR′ independently comprises at least one of an alkyl, an alkenyl, an alkynyl, a cycloalkyl, an aryl, a silyl, a silylalkyl, an aminoalkyl, an alkoxyalkyl, an aralkyl, a fluoroalkyl, a haloalkyl, a silylated alkoxide, an ether, an amine, a halide, an imide, a cyanate, a nitrile, an alkoxide, a carboxylate, an enolate, an ester, a cyclopentadienyl, or any combination thereof.

26. The method of claim 25, wherein M is Ti, Zr, or Hf.

27. The method of claim 25, wherein OR′ comprises tert-butyl.

28. The method of claim 25, wherein OR′ comprises trimethylsilyl.

29. The method of claim 1, wherein the at least one reaction product comprises a metal alkoxide compound of at least one of the following formulas: [chemical structure]
